(19) United States
(12) Patent Application Publication
(10) Pub. No.: US 2026/0273649 A1
(43) Pub. Date: Sep. 17, 2026

(54) DEVICE, CONTROL DEVICE, AND METHOD FOR CORRECTING PRESSURE FORCE COMMAND OF WELDING GUN

(71) Applicant: Fanuc Corporation, Minamitsuru-gun, Yamanashi (JP)

(72) Inventors: Akinori NISHIMURA, Minamitsuru-gun, Yamanashi (JP); Toshimichi AOKI, Minamitsuru-gun, Yamanashi (JP)

(73) Assignee: Fanuc Corporation, Minamitsuru-gun, Yamanashi (JP)

(21) Appl. No.: 18/873,807

(22) PCT Filed: Jun. 23, 2022
(86) PCT No.: PCT/JP2022/025192

§ 371 Date: Dec. 11, 2024

(51) Int. Cl. B23K 11/24; B23K 11/11; B23K 37/02

(52) U.S. Cl. CPC B23K 11/24; B23K 11/11; B23K 37/0211

(57) ABSTRACT

A device includes: an operation execution unit that causes a robot to operate so as to position a welding gun at a teaching attitude defined in a welding work program; a pressure force acquisition unit that acquires a pressure force from when the welding gun is positioned at the teaching attitude by the operation execution unit and is driven by a first pressure force command; and a command correction unit that corrects the first pressure force command on the basis of the pressure force acquired by the pressure force acquisition unit, thereby calculating a second pressure force command for driving the welding gun at the teaching attitude at the time of execution of the welding work program.

### CROSS REFERENCE TO RELATED APPLICATIONS

This is the U.S. National Phase application of PCT/JP2022/025192, filed Jun. 23, 2022, the disclosure of this application being incorporated herein by reference in its entirety for all purposes.

### FIELD OF THE INVENTION

The present disclosure relates to a device, controller, and method for correcting a pressurizing force command for determining a pressurizing force of a welding gun.

### BACKGROUND OF THE INVENTION

A device is known that corrects a pressurizing force command for determining a pressurizing force of a welding gun in response to an orientation of the welding gun (e.g., Patent Document 1).

### PATENT LITERATURE

Patent Document 1: JP 2001-47249 A

### SUMMARY OF THE INVENTION

There is a need for a technique of highly accurately correcting the pressurizing force command and simplifying a work for the correction.

According to an aspect of the present disclosure, in a device configured to correct a pressurizing force command defining a pressurizing force of a welding gun, in response to an orientation of the welding gun, the welding gun being moved by a robot and configured to pressurize a workpiece to perform welding on the workpiece, the device includes: an operation execution unit configured to operate the robot so as to position the welding gun at a teaching orientation defined in a welding work program for causing the robot and the welding gun to perform a welding work; a pressurizing force acquisition unit configured to acquire the pressurizing force when the welding gun is positioned at the teaching orientation by the operation execution unit and driven in accordance with a first pressurizing force command; and a command correction unit configured to obtain a second pressurizing force command for when driving the welding gun at the teaching orientation during execution of the welding work program, by correcting the first pressurizing force command based on the pressurizing force acquired by the pressurizing force acquisition unit.

According to another aspect of the present disclosure, in a method of correcting a pressurizing force command defining a pressurizing force of a welding gun, in response to an orientation of the welding gun, the welding gun being moved by a robot and configured to pressurize a workpiece to perform welding on the workpiece, the method includes: operating, by a processor, the robot so as to position the welding gun at a teaching orientation defined in a welding work program for causing the robot and the welding gun to perform a welding work; acquiring, by the processor, the pressurizing force when the welding gun is positioned at the teaching orientation and driven in accordance with a first pressurizing force command; and obtaining, by the processor, a second pressurizing force command for when driving the welding gun at the teaching orientation during execution of the welding work program, by correcting the first pressurizing force command based on the acquired pressurizing force.

According to the present disclosure, the pressurizing force command is corrected by using the teaching orientation at which the welding gun is to be positioned in the actual welding work, thereby highly accurately obtaining the second pressurizing force command that allows the welding gun to generate a constant pressurizing force regardless of the orientation. Furthermore, since there is no need for newly teaching the robot the orientation for correcting the pressurizing force command, the work for correcting the pressurizing force command can be simplified.

### BRIEF DESCRIPTION OF THE DRAWINGS

FIG. 1 is a schematic view of a welding robot system according to an embodiment.

FIG. 2 is a block diagram of the welding robot system illustrated in FIG. 1.

FIG. 3 is an enlarged view of a welding gun illustrated in FIG. 1.

FIG. 4 illustrates a state in which the orientation of the welding gun illustrated in FIG. 3 is changed.

FIG. 5 is a flowchart illustrating an example of a method of correcting a pressurizing force command performed by the welding robot system illustrated in FIG. 1.

FIG. 6 illustrates an example of a welding work program.

FIG. 7 illustrates an example of a position data table.

FIG. 8 illustrates an example of a welding condition data table.

FIG. 9 is an enlarged view of a welding gun according to another embodiment.

FIG. 10 is a schematic view of a welding robot system according to another embodiment.

FIG. 11 is a block diagram of the welding robot system illustrated in FIG. 10.

FIG. 12 is a flowchart illustrating an example of a method of correcting a pressurizing force command performed by the welding robot system illustrated in FIG. 10.

FIG. 13 is a block diagram illustrating other functions of the welding robot system illustrated in FIG. 11.

FIG. 14 is a flowchart illustrating an example of a method of correcting a pressurizing force command performed by the welding robot system illustrated in FIG. 13.

FIG. 15 is a block diagram illustrating other functions of the welding robot system illustrated in FIG. 2.

FIG. 16 is a flowchart illustrating an example of a method of correcting a pressurizing force command performed by the welding robot system illustrated in FIG. 15.

FIG. 17 is a flowchart illustrating an example of a flow of step S35 in FIG. 16.

FIG. 18 illustrates another example of the position data table.

FIG. 19 illustrates an example of an orientation reproduction program.

FIG. 20 illustrates still another example of the position data table.

FIG. 21 is a block diagram illustrating still another function of the welding robot system illustrated in FIG. 11.

FIG. 22 is a flowchart illustrating an example of a method of correcting a pressurizing force command performed by the welding robot system illustrated in FIG. 21.

FIG. 23 is a flowchart illustrating an example of a flow of step S54 in FIG. 22.

FIG. 24 illustrates still another example of the position data table.

FIG. 25 illustrates another example of the orientation reproduction program.

### DETAILED DESCRIPTION OF EMBODIMENTS OF THE INVENTION

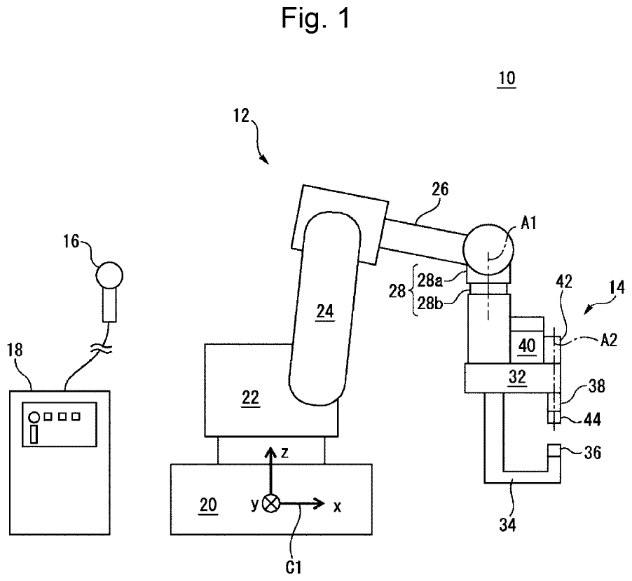

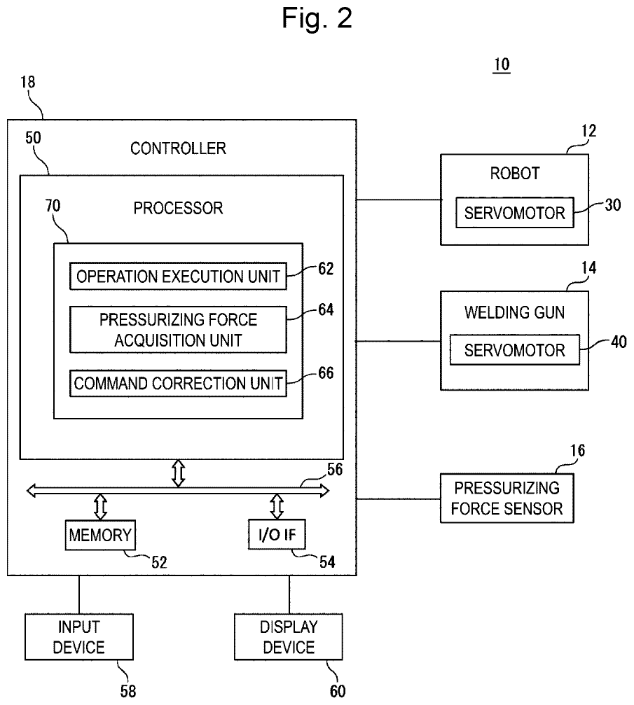

Embodiments of the present disclosure are described in detail below with reference to the drawings. Note that in various embodiments described below, the same elements are denoted with the same reference numerals, and overlapping description is omitted. First, a welding robot system 10 according to an embodiment will be described with reference to FIGS. 1 and 2. The welding robot system 10 includes a robot 12, a welding gun 14, a pressurizing force sensor 16, and a controller 18.

In the present embodiment, the robot 12 is a vertical articulated robot, and includes a robot base 20, a rotary barrel 22, a lower arm part 24, an upper arm part 26, and a wrist part 28. The robot base 20 is secured on the floor of a work cell. The rotary barrel 22 is mounted on the robot base 20 to be rotatable around a vertical axis.

The lower arm part 24 is provided to the rotary barrel 22 so as to be rotatable around the horizontal axis. The upper arm part 26 is rotatably provided at the distal end portion of the lower arm part 24. The wrist part 28 includes a wrist base 28a provided to be rotatably at the distal end portion of the upper arm part 26 and a wrist flange 28b provided at the wrist base 28a being rotatable around a wrist axis A1.

The robot base 20, the rotary barrel 22, the lower arm part 24, the upper arm part 26, and the wrist part 28 are respectively provided with a plurality of servomotors 30 (FIG. 2). The servomotors 30 rotate each movable component of the robot 12 (i.e., the rotary barrel 22, the lower arm part 24, the upper arm part 26, the wrist part 28, and the wrist flange 28b) in response to a command from the controller 18, thereby moving the welding gun 14.

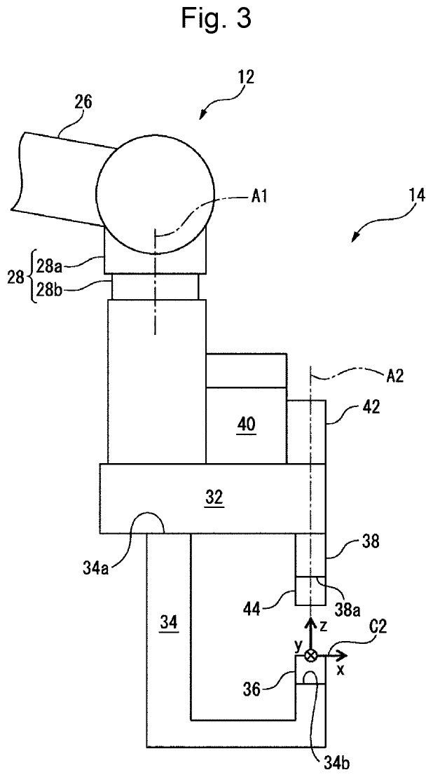

The welding gun 14 is detachably attached to the wrist flange 28b. As illustrated in FIG. 3, in the present embodiment, the welding gun 14 is a so-called C-type spot welding gun, and includes a base part 32, a fixed arm 34, a fixed welding tip 36, a movable arm 38, a servomotor 40, a motion conversion mechanism 42, and a movable welding tip 44.

The base part 32 is coupled to the wrist flange 28b. A proximal end 34a of the fixed arm 34 is fixed to the base part 32, and is extended and curved in a substantially L-shape from the proximal end 34a to a distal end 34b. The fixed welding tip 36 is fixed to the distal end 34b of the fixed arm 34.

The movable arm 38 is provided at the base part 32 so as to be movable back and forth along the gun axis A2. In the present embodiment, the movable arm 38 is a rod-shaped member linearly extending along the gun axis A2. The movable welding tip 44 is fixed to a distal end 38a of the movable arm 38 so as to be aligned with the fixed welding tip 36 on a gun axis A2. Note that the gun axis A2 and the wrist axis A1 may be arranged in parallel.

The servomotor 40 includes an output shaft (not illustrated) and is fixed to the base part 32. The motion conversion mechanism 42 includes a ball screw mechanism, or a mechanism including a timing belt and a pulley, and converts the rotational movement of the output shaft of the servomotor 40 to a back-and-forth movement of the movable arm 38 along the gun axis A2, for example.

The controller 18 controls the operation of the robot 12 and the welding gun 14. As illustrated in FIG. 2, the controller 18 is a computer including a processor 50, a memory 52, and an I/O interface 54. The processor 50, including a CPU, a GPU, or the like, is communicatively connected to the memory 52 and the I/O interface 54 via a bus 56, and executes arithmetic processing for a pressurizing force command correction function described later while communicating with these components.

The memory 52 includes a RAM, a ROM, or the like, and temporarily or permanently stores various types of data used for the arithmetic processing executed by the processor 50 and various types of data generated during the arithmetic processing. The I/O interface 54 includes, for example, an Ethernet (trade name) port, an USB port, an optical fiber connector, or an HDMI (trade name) terminal and communicates data wiredly or wirelessly with an external device in accordance with a command from the processor 50. In the present embodiment, the servomotors 30 and 40 and the pressurizing force sensor 16 are communicatively connected to the I/O interface 54 by wire or wirelessly.

The controller 18 is further provided with an input device 58 and a display device 60. The input device 58 includes a keyboard, a mouse, a touch panel, or the like, and receives input of data from an operator. The display device 60 includes a liquid crystal display, an organic EL display, or the like and displays various types of data.

The input device 58 and the display device 60 are communicatively connected to the I/O interface 54 by wire or wirelessly. The input device 58 and the display device 60 may be integrally incorporated in a housing of the controller 18, or may be provided as one computer (such as a PC) that is a component separate from the housing of the controller 18, for example.

As illustrated in FIG. 1, a robot coordinate system C1 is set to the robot 12. The robot coordinate system C1 is a coordinate system for automatically controlling each movable component of the robot 12. In the present embodiment, the robot coordinate system C1 is set to the robot 12 such that the origin is located at the center of the robot base 20 and the z axis coincides with the turning axis of the rotary barrel 22.

On the other hand, as illustrated in FIG. 3, a tool coordinate system C2 is set to the welding gun 14. The tool coordinate system C2 is a coordinate system for defining the position and the orientation of the welding gun 14 in the robot coordinate system C1. In the present embodiment, the tool coordinate system C2 is set to the welding gun 14 such that the origin (a so-called TCP) is located on the fixed welding tip 36 (e.g., the center of the distal end surface), and the z axis coincides with (or parallel to) the gun axis A2.

When moving the welding gun 14, the processor 50 first sets the tool coordinate system C2 to the robot coordinate system C1, and generates a command (position command, speed command, torque command, or the like) to each servomotor 30 of the robot 12 such that the welding gun 14 is positioned at a position and an orientation represented by the set tool coordinate system C2. Thus, the welding gun 14 is moved by the operation of the robot 12, to be positioned at any position and orientation in the robot coordinate system C1.

The welding gun 14 pressurizes a workpiece (not illustrated) to perform welding. Specifically, the processor 50 sends a pressurizing force command F_{C} to the servomotor 40 to move the movable arm 38 along the gun axis A2, thereby moving the movable welding tip 44 toward the fixed welding tip 36. As a result, the workpiece is held between the movable welding tip 44 and the fixed welding tip 36. In this state, a pressurizing force F corresponding to the pressurizing force command F_{C} is applied from the movable welding tip 44 to the workpiece.

The processor 50 then activates the fixed welding tip 36 and the movable welding tip 44, and energizes the fixed welding tip 36 and the movable welding tip 44. As a result, welding is performed on the workpiece held between the fixed welding tip 36 and the movable welding tip 44. The pressurizing force command F_{C} sent to the servomotor 40 is a command that defines the pressurizing force F to be generated by the welding gun 14, and represents a target value (e.g., 2 [kN]) of the pressurizing force F.

The pressurizing force sensor 16 includes a piezoelectric element, a strain gauge, or the like, and measures the pressurizing force F of the welding gun 14. Specifically, the pressurizing force sensor 16 is configured to be held by one hand of the operator, and is manually set between the fixed welding tip 36 and the movable welding tip 44 by the operator when measuring the pressurizing force F. The pressurizing force sensor 16 is held between the movable welding tip 44 driven by the servomotor 40 and the fixed welding tip 36, and measures the pressurizing force F applied to the pressurizing force sensor 16 in this state. The pressurizing force sensor 16 supplies detection data of the measured pressurizing force F to the controller 18.

Here, the pressurizing force F generated by the welding gun 14 when the welding gun 14 is driven in accordance with the predetermined pressurizing force command F_{C} may change in response to the orientation of the welding gun 14. For example, in the example illustrated in FIG. 3, the welding gun 14 is arranged at an orientation OR₀ at which the gun axis A2 is parallel to the vertical direction and the movable welding tip 44 is aligned vertically above the fixed welding tip 36.

It is assumed that with this orientation OR₀, the processor 50 drives the servomotor 40 in accordance with a predetermined pressurizing force command F_{C_0} (e.g., F_{C_0}=1 [kN]), and the welding gun 14 pressurizes a pressurization target object (e.g., the fixed welding tip 36) with the movable welding tip 44 according to the pressurizing force command F_{C_0}.

In this case, a pressurizing force F₀ applied from the movable welding tip 44 to the pressurization target object is a total force F₀ (=F_{τ}+F_{g}) of a force component F_{τ} obtained by converting the torque of the servomotor 40 in the direction of the gun axis A2 by the motion conversion mechanism 42 and a gravitational force component F_{g} of the movable portion of the welding gun 14 including the motion conversion mechanism 42, the movable arm 38, and the movable welding tip 44.

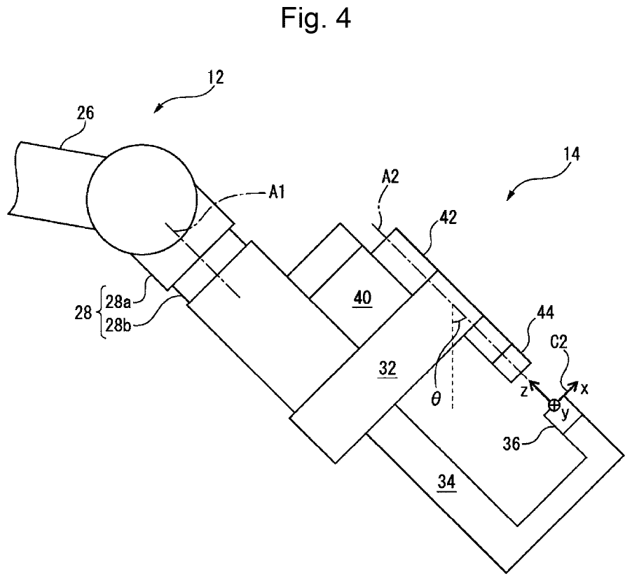

Next, it is assumed that the welding gun 14 is rotated by an angle θ around the y axis of the tool coordinate system C2 from the orientation OR₀ illustrated in FIG. 3 to be arranged at an orientation OR_{θ} illustrated in FIG. 4, and the processor 50 drives the servomotor 40 with the same pressurizing force command F_{C_0} to pressurize the pressurization target object by the movable welding tip 44. A pressurizing force F_{θ} applied in this state from the movable welding tip 44 to the pressurization target object is a total force F_{θ} (=F_{τ}+F_{g} cos θ) of the force component F_{τ} described above and a force component F_{g} cos θ obtained by multiplying the gravitational force component F_{g} described above by cos θ.

Therefore, the pressurizing force F_{θ} at the orientation OR_{θ} is smaller than the pressurizing force F₀ at the orientation OR₀ illustrated in FIG. 3 by F_{g} (1−cos θ). Thus, the pressurizing force F changes in accordance with the orientation OR of the welding gun 14. Such a change in the pressurizing force F in accordance with the orientation OR affects the welding quality.

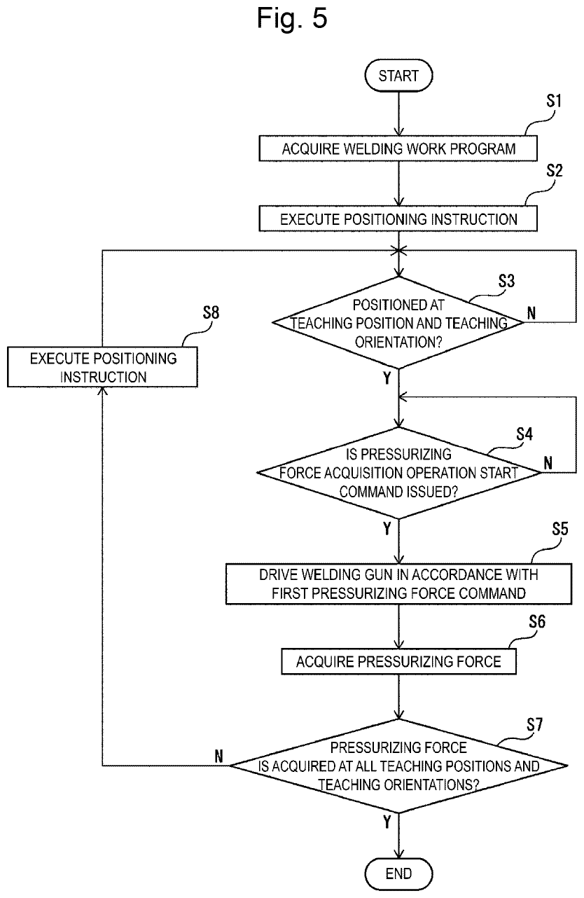

Therefore, in the present embodiment, the processor 50 corrects the pressurizing force command F_{C} in accordance with the orientation OR of the welding gun 14. Hereinafter, a method of correcting the pressurizing force command F_{C} will be described with reference to FIG. 5. The flow illustrated in FIG. 5 starts when the processor 50 receives a correction start command from the operator, a host controller, or the like.

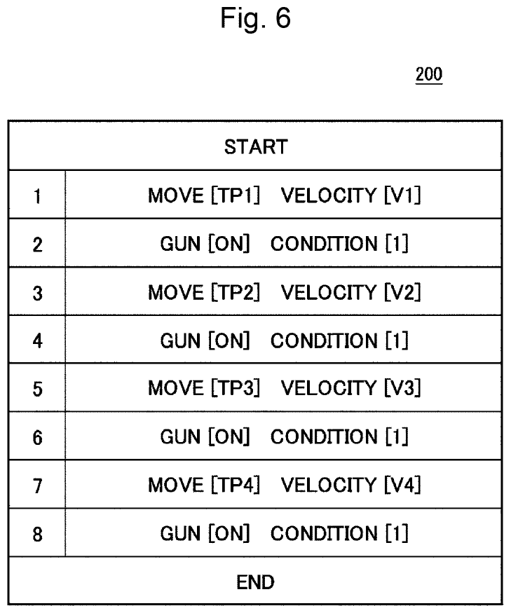

In step S1, the processor 50 acquires a welding work program 200. The welding work program 200 is a computer program for causing the robot 12 and the welding gun 14 to perform a welding work. FIG. 6 schematically illustrates an example of the welding work program 200.

In the welding work program 200 illustrated in FIG. 6, for example, a code “MOVE [TP1] VELOCITY [V1]” in the first line is a positioning instruction IN_{P} for causing the robot 12 to move the welding gun 14 at a velocity V=V₁ [mm/sec] and position the welding gun 14 at a first teaching position TP₁ and a first teaching orientation OR₁ indicated by an identifier [TP1].

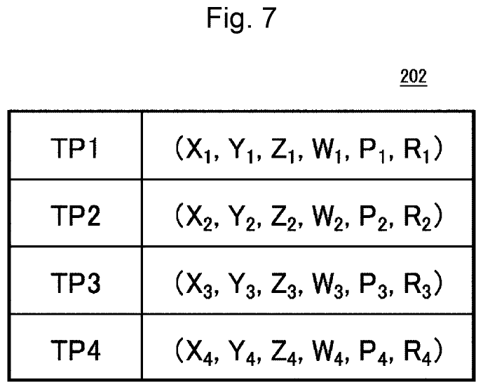

On the other hand, as data different from the welding work program 200, a position data table 202 is generated and stored in the memory 52 in advance. FIG. 7 schematically illustrates an example of the position data table 202. The position data table 202 illustrated in FIG. 7 stores coordinate data pieces respectively assigned identifiers “TP1”, “TP2”, “TP3”, and “TP4”.

For example, the identifier “TP1” is assigned to coordinates (X₁, Y₁, Z₁, W₁, P₁, R₁). Of the coordinates (X₁, Y₁, Z₁, W₁, P₁, R₁), coordinates (X₁, Y₁, Z₁) are coordinates in the robot coordinate system C1 where the welding gun 14 (specifically, TCP) is to be positioned, and represent the first teaching position TP1. On the other hand, coordinates (W₁, P₁, R₁) are coordinates defining axis directions (so-called yaw, pitch, and roll) of the tool coordinate system C1 in the robot coordinate system C2, and represent a first teaching orientation OR₁.

When reading the positioning instruction IN_{P} “MOVE [TP1] VELOCITY [V1]” in the first line during execution of the welding work program 200, the processor 50 refers to the position data table 202 and acquires the coordinates (X₁, Y₁, Z₁, W₁, P₁, R₁) indicated by the identifier “TP1” from the position data table 202.

Then, the processor 50 sets, to the robot coordinate system C1, the tool coordinate system C2 of the origin position and the axis directions represented by the coordinates (X₁, Y₁, Z₁, W₁, P₁, R₁), and generates a command (such as position command, speed command, and torque command) to the servomotors 30 of the robot 12, for moving the welding gun 14 at the velocity V₁ to the first teaching position TP1 and the first teaching orientation OR₁ represented by the set tool coordinate system C2. Thus, the processor 50 operates the robot 12 according to the positioning instruction IN_{P} to position the welding gun 14 at the first teaching position TP1 and the first teaching orientation OR₁.

As described above, in the present embodiment, an nth teaching position TPₙ and an nth teaching orientation ORₙ (n=1, 2, 3, 4) are defined in the welding work program 200. The operator teaches the robot 12 each of the nth teaching position TPₙ and the nth teaching orientation ORₙ in advance using a teaching device (a teach pendant, a tablet terminal device, or the like).

In a code “[Vn]” defining the velocity V in a code “MOVE [TPn] VELOCITY [Vn]” (n=1, 2, 3, 4) of each positioning instruction IN_{P}, a numerical value (e.g., 50 [mm/sec]) of the velocity Vₙ may be described. Alternatively, the ratio [%] of a maximum velocity VMAX at which the robot 12 moves the welding gun 14 may be described in “[Vn]” (e.g., “80%”).

Alternatively, similarly to the above-described position data table 202, a velocity data table storing the velocity Vₙ together with the identifier “Vn” may be prepared in advance as data different from the welding work program 200. In this case, upon reading the positioning instruction IN_{P} “MOVE [TPₙ] VELOCITY [Vn]” in the 2i−1th line (i=1, 2, 3, 4), the processor 50 refers to the velocity data table and acquires the velocity Vₙ to which the identifier “Vn” is assigned from the velocity data table. The velocities Vₙ: “VELOCITY [Vn]” defined in the welding work program 200 may be different from each other, or at least two (e.g., all) of the velocities Vₙ may be the same.

Referring back to FIG. 6, in the welding work program 200, a code “GUN [ON] CONDITION [1]” in the 2ith line (i=1, 2, 3, 4) is a welding instruction IN_{W} for activating the welding gun 14 for performing welding on the workpiece according to a welding condition 1 to which an identifier [1] is assigned.

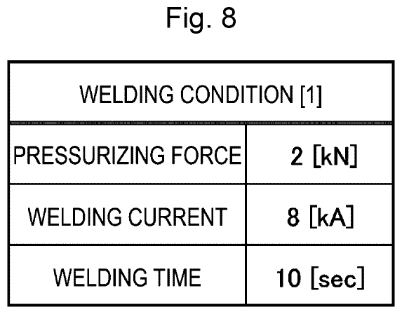

The target of this welding may include a plurality of types of workpieces that have various thicknesses and made of various materials. In the present embodiment, a plurality of welding conditions m (m=1, 2, 3, . . . ) different from each other are set in advance for each type of workpiece. FIG. 8 illustrates an example of the welding condition 1 to which the identifier [1] is assigned.

In the welding condition 1, parameters such as a pressurizing force F₁=2 [kN], a welding current I₁=8 [kA], and a welding time t₁=10 [sec] are set. An example data table (pressurizing force Fₘ, welding current Iₘ, welding time tₘ) for a welding condition m as illustrated in FIG. 8 is prepared for each type (that is, thickness and material) of the workpiece and stored in the memory 52 in advance. For the welding condition m, any parameter (e.g., a welding voltage or the like) other than the pressurizing force Fₘ, the welding current Iₘ, and the welding time tₘ may be set.

Upon reading the welding instruction IN_{W} “GUN [ON] CONDITION [1]” in the 2ith line during execution of the welding work program 200, the processor 50 refers to the data table for the welding condition 1 to which the identifier [1] is assigned, and acquires the parameters of the welding condition 1 such as the pressurizing force F₁=2 [kN], the welding current I₁=8 [kA], and the welding time t₁=10 [sec].

Then, the processor 50 generates a pressurizing force command F_{C_1} (=2 [kN]) corresponding to the pressurizing force F₁ defined in the welding condition 1, drives the servomotor 40 of the welding gun 14 according to the pressurizing force command F_{C_1}, and holds the workpiece between the movable welding tip 44 and the fixed welding tip 36.

On the other hand, the servomotor 40 of the welding gun 14 is provided with a load detection sensor LS (not illustrated) that detects a load torque, a feedback current, or the like of the servomotor 40. The processor 50 acquires feedback FB1 (i.e., the load torque, the feedback current, or the like) from the load detection sensor LS.

Here, a calibration work is performed in advance to make the pressurizing force command F_{C} to the servomotor 40 and the pressurizing force F generated by the welding gun 14 driven according to the pressurizing force command F_{C} match. This calibration work is executed, for example, in a state where the welding gun 14 is arranged at the predetermined reference orientation OR₀ by the robot 12. The reference orientation OR₀ is, for example, the orientation illustrated in FIG. 3.

In this calibration work, the operator sets the pressurizing force sensor 16 between the movable welding tip 44 and the fixed welding tip 36 of the welding gun 14 arranged at the reference orientation OR₀, and measures the pressurizing force F at the time when the welding gun 14 is driven according to the pressurizing force command F_{C} using the pressurizing force sensor 16. The operator acquires the correlation between the feedback FB1 from the load detection sensor LS at this time and the measured pressurizing force F, and calibrates the correlation to make the pressurizing force command F_{C} and the pressurizing force F match.

The processor 50 acquires the feedback FB1 from the load detection sensor LS while driving the servomotor 40 according to the pressurizing force command F_{C_1} in accordance with the welding instruction IN_{W}, and stops the servomotor 40 when the feedback FB1 reaches a value corresponding to the pressurizing force command F_{C_1}.

Next, the processor 50 energizes the fixed welding tip 36 and the movable welding tip 44 by the welding current I₁ (=8 [kA]) defined in the welding condition 1, and performs the welding on the workpiece for the welding time t₁ (=10 [sec]). In this way, the processor 50 performs the welding work on the workpiece by executing the welding instruction IN_{W}.

In step S1, the processor 50 acquires the welding work program 200 including the positioning instruction IN_{P} and the welding instruction IN_{W} as described above. For example, the welding work program 200 is stored in the memory 52 in advance, and the processor 50 acquires the welding work program 200 by reading from the memory 52.

Alternatively, the welding work program 200 may be stored in another computer (a host controller, a production management server, a teaching device, or the like). The other computer may be communicatively connected to the I/O interface 54 of the controller 18 via a communication network (Internet, LAN). The processor 50 may acquire the welding work program 200 through downloading from the other computer.

In step S2, the processor 50 executes the positioning instruction IN_{P} in the welding work program 200. In the present embodiment, in step S2, the processor 50 reads the positioning instruction IN_{P} “MOVE [TP1] VELOCITY [V1]” defined in the first line in the welding work program 200, and makes the robot 12 move the welding gun 14 at the velocity V₁ so as to position the welding gun 14 at the first teaching position TP1 and the first teaching orientation OR₁. Thus, in the present embodiment, the processor 50 functions as an operation execution unit 62 (FIG. 2) that operates the robot 12 so as to position the welding gun 14 at the teaching orientation ORₙ defined in the welding work program 200.

In step S3, the processor 50 determines whether or not the welding gun 14 has been positioned at the nth teaching position TPₙ and the nth teaching orientation ORₙ. Specifically, the processor 50 can determine whether or not the welding gun 14 is positioned at the nth teaching position TPₙ and the nth teaching orientation ORₙ based on feedback FB2 (e.g., position feedback, velocity feedback, or acceleration feedback of the servomotor 30) from a rotation detection sensor RS1 (encoder, Hall sensor, or the like) provided in each servomotor 30 of the robot 12.

For example, when step S3 is executed after step S2, the processor 50 determines whether or not the welding gun 14 is positioned at the first teaching position TP1 and the first teaching orientation OR₁. When the processor 50 determines that the welding gun 14 has been positioned at the nth teaching position TPₙ and the nth teaching orientation ORₙ (i.e., determines YES), the processor 50 stops the operation of the robot 12 and proceeds to step S4. As a result, the welding gun 14 stops in a state of being positioned at the nth teaching position TPₙ and the nth teaching orientation ORₙ. On the other hand, upon determining NO, the processor 50 repeats step S3.

Upon determining YES in step S3, the processor 50 reads the welding instruction IN_{W} defined in the line subsequent to the positioning instruction IN_{P} executed in step S2 (or step S8 to be described later executed most recently) in the welding work program 200. However, in the flow in FIG. 5, the processor 50 does not execute the welding instruction IN_{W}, but instead executes a pressurizing force acquisition operation FO.

In the present embodiment, a flag FL for executing the pressurizing force acquisition operation FO described later instead of the welding instruction IN_{W}, is set in the controller 18. When the flag FL is ON, the processor 50 does not execute the welding instruction IN_{W} read upon determining YES in step S3, but instead executes steps S4 to S7 described later as the pressurizing force acquisition operation FO.

For example, the operator or the host controller may transmit a flag setting signal to the controller 18, and the processor 50 may switch the flag FL between ON and OFF in response to the flag setting signal. When the flow in FIG. 5 is executed, the operator or the host controller issues the flag setting signal for turning ON the flag FL to the controller 18, and the processor 50 turns ON the flag FL in response to the flag setting signal. Thus, upon determining YES in step S3 during execution of the flow in FIG. 5, the processor 50 executes steps S4 to S7 as the pressurizing force acquisition operation FO instead of executing the welding instruction IN_{W}.

In step S4, the processor 50 determines whether or not a pressurizing force acquisition operation start command is received from the operator. For example, the processor 50 generates a notification signal SG1 of an image or a sound providing a message “set pressurizing force sensor between movable welding tip and fixed welding tip”, and displays the notification signal SG1 as an image on the display device 60 or outputs the notification signal SG1 as a sound from a speaker (not illustrated) provided in the controller 18.

The operator manually sets the pressurizing force sensor 16 between the movable welding tip 44 and the fixed welding tip 36, and operates the input device 58 to issue the pressurizing force acquisition operation start command to the processor 50. The processor 50 proceeds to step S5 upon determining YES, that is, determining that the pressurizing force acquisition operation start command has been received or repeats step S4 upon determining NO.

In step S5, the processor 50 drives the welding gun 14 according to a pressurizing force command F_{C_m} (first pressurizing force command) corresponding to the pressurizing force Fₘ defined in the welding condition m. Specifically, the processor 50 acquires the pressurizing force F₁ (=2 [kN]) defined in the welding condition 1 to which the identifier [1] is assigned in accordance with a code “CONDITION [1]” of the welding instruction IN_{W} read when the determination result is YES in the most recent step S3. Then, the processor 50 generates the pressurizing force command F_{C_1} (=2 [kN]) corresponding to the pressurizing force F₁ acquired from the welding condition 1, and drives the servomotor 40 of the welding gun 14 according to the pressurizing force command F_{C_1}.

On the other hand, the processor 50 acquires the feedback FB1 from the above-described load detection sensor LS while driving the servomotor 40, and stops the servomotor 40 when the feedback FB1 reaches a value corresponding to the pressurizing force command F_{C_1}. As a result, the pressurizing force sensor 16 is held between the movable welding tip 44 and the fixed welding tip 36, and the pressurizing force F corresponding to the pressurizing force command F_{C_1} is applied to the pressurizing force sensor 16.

In step S6, the processor 50 acquires the pressurizing force F. Specifically, the processor 50 acquires the pressurizing force F measured by the pressurizing force sensor 16 at the end of step S5 (that is, when the servomotor 40 is stopped) from the pressurizing force sensor 16, and stores the pressurizing force F in the memory 52. As described above, in the present embodiment, the processor 50 acquires the pressurizing force F actually measured by the pressurizing force sensor 16 when the welding gun 14 positioned at the nth teaching position TPₙ and the nth teaching orientation ORₙ in the most recent step S2 (or step S8 described later) is driven in accordance with the pressurizing force command F_{C_1}. Thus, the processor 50 functions as a pressurizing force acquisition unit 64 (FIG. 2) that acquires the pressurizing force F. The pressurizing force F acquired in step S6 may be different from the pressurizing force command F_{C_1} (i.e., the pressurizing force F₁=2 [kN] defined in the welding condition 1) depending on the nth teaching orientation ORₙ at which the welding gun 14 is positioned even if the above-described calibration work is executed.

In step S7, the processor 50 determines whether or not the pressurizing force F has been acquired for all of the teaching positions TPₙ and the teaching orientations ORₙ defined in the welding work program 200. The processor 50 ends the flow illustrated in FIG. 5 when determining YES and proceeds to step S8 when determining NO.

In step S8, the processor 50 executes the positioning instruction IN_{P} defined in the subsequent line in the welding work program 200. For example, when executing step S8 for the first time, the processor 50 executes a positioning instruction IN_{P} “MOVE [TP2] VELOCITY [V2]” in the third line to move the welding gun 14 at a velocity V₂ so as to position the welding gun 14 at a second teaching position TP₂ and a second teaching orientation OR₂.

Then, the processor 50 returns to step S3. In this way, the processor 50 repeatedly executes the loop of steps S3 to S8 until determining YES in step S7, and acquires the pressurizing force F in step S6 every time the welding gun 14 is positioned at the nth teaching position TPₙ and the nth teaching orientation ORₙ by executing step S8.

After ending the flow illustrated in FIG. 5, the processor 50 executes the welding work program 200 to perform the actual welding work on the workpiece. When the actual welding work is performed, the operator or the host controller issues the flag setting signal for turning OFF the flag FL to the controller 18, and the processor 50 turns OFF the flag FL in response to the flag setting signal. As a result, in the actual welding work, the processor 50 performs the welding work on the workpiece by executing the welding instruction IN_{W} in the welding work program 200.

In the present embodiment, when the welding work program 200 is executed for the actual welding work, the processor 50 corrects the pressurizing force command F_{C_1} based on the pressurizing force F acquired in step S6 described above. For example, it is assumed that the pressurizing force F acquired in step S2 or S8 described above immediately after the welding gun 14 has been positioned at the nth teaching position TPₙ and the nth teaching orientation ORₙ by executing the positioning instruction IN_{P} in the 2i−1th line in step S6 is 1.5 [kN].

In this case, the processor 50 obtains a correction amount ΔF for correcting the pressurizing force command F_{C_1} (=2 [kN]) for driving the servomotor 40 of the welding gun 14 when executing the welding instruction IN_{W} in the 2ith line subsequent to the positioning instruction IN_{P} in the 2i−1th line in the actual welding work, for example, as a difference ΔF (=0.5 [kN]) between the acquired pressurizing force F and the pressurizing force command F_{C_1}.

Then, the processor 50 corrects the pressurizing force command F_{C_1} by adding the correction amount ΔF to obtain a new pressurizing force command F_{C_1}′=2.5 [kN] (second pressurizing force command). The correction amount ΔF is not limited to the difference between the pressurizing force F and the pressurizing force command F_{C_1}, and may be, for example, a value obtained by multiplying the difference by a predetermined coefficient, or may be obtained by any other calculation using the pressurizing force F and the pressurizing force command F_{C_1}.

Then, the processor 50 drives the servomotor 40 according to the corrected pressurizing force command F_{C_1}′ (=2.5 [kN]) during execution of the welding instruction IN_{W} in the 2ith line. As a result, the pressurizing force F applied to the workpiece by the welding gun 14 positioned at the nth teaching orientation ORₙ in the actual welding work can be made substantially equal to the pressurizing force F₁ defined in the welding condition 1.

As described above, in the present embodiment, the processor 50 functions as a command correction unit 66 (FIG. 2) that corrects the first pressurizing force command F_{C_1} based on the pressurizing force F acquired in step S6 to obtain the second pressurizing force command F_{C_1}′ for when driving the welding gun 14 at the teaching orientation ORₙ during execution of the welding work program 200.

As described above, in the present embodiment, the processor 50 functions as the operation execution unit 62, the pressurizing force acquisition unit 64, and the command correction unit 66 to correct the pressurizing force command F_{C} defining the pressurizing force F of the welding gun 14 in accordance with the orientation OR of the welding gun 14. Therefore, the operation execution unit 62, the pressurizing force acquisition unit 64, and the command correction unit 66 form a device 70 (FIG. 2) that corrects the pressurizing force command F_{C} in accordance with the orientation OR of the welding gun 14.

In this device 70, the operation execution unit 62 operates the robot 12 so as to position the welding gun 14 at the teaching orientation ORₙ defined in the welding work program 200 (steps S2 and S8), and the pressurizing force acquisition unit 64 obtains the pressurizing force F when the welding gun 14 is driven in accordance with the first pressurizing force command F_{C_1} with the welding gun 14 positioned at the teaching orientation ORₙ by the operation execution unit 62 (step S6). Then, the command correction unit 66 corrects the first pressurizing force command F_{C_1} based on the pressurizing force F acquired by the pressurizing force acquisition unit 64 to obtain the second pressurizing force command F_{C_1}′ for when the welding gun 14 is driven at the teaching orientation ORₙ during execution of the welding work program 200.

According to this configuration, the pressurizing force command F_{C_1} can be corrected based on the pressurizing force F acquired at the teaching orientation ORₙ in which the welding gun 14 is to be positioned in the actual welding work. Thus, the second pressurizing force command F_{C_1}′ that allows the welding gun 14 to generate the constant pressurizing force F regardless of the orientation at which the welding gun 14 is to be positioned in the actual welding work can be obtained with high accuracy. Furthermore, since there is no need for newly teaching the robot 12 the orientation for correcting the pressurizing force command F_{C_1}, the work for correcting the pressurizing force command F_{C_1} can be simplified.

In the device 70, the welding work program 200 includes the positioning instruction IN_{P} for operating the robot 12 to position the welding gun 14 at the nth teaching position TPₙ and the nth teaching orientation ORₙ, and the welding instruction IN_{W} for activating the welding gun 14 to perform welding on the workpiece. Then, the operation execution unit 62 executes the positioning instruction IN_{P} in the welding work program 200 to position the welding gun 14 at the nth teaching position TPₙ and the nth teaching orientation ORₙ by the robot 12 (steps S2 and S8), while not executing the welding instruction IN_{W} (steps S4 to S7).

Then, the pressurizing force acquisition unit 64 acquires the pressurizing force F with the welding gun 14 positioned at the nth teaching position TPₙ and the nth teaching orientation ORₙ by the operation execution unit 62 (step S6). With this configuration, the pressurizing force F for correcting the pressurizing force command F_{C_1} can be acquired with the robot 12 performing the same operation as the actual welding work. Therefore, the operation of acquiring the pressurizing force F can be executed while avoiding interference between the robot 12 and the peripheral equipment at the site of the welding work.

In the device 70, the pressurizing force acquisition unit 64 acquires the pressurizing force F measured by the pressurizing force sensor 16 when the welding gun 14 positioned at the nth teaching orientation ORₙ by the operation execution unit 62 is driven in accordance with the first pressurizing force command F_{C_1}. With this configuration, since the pressurizing force F can be measured with high accuracy by the pressurizing force sensor 16, the second pressurizing force command F_{C_1}′ can be obtained with higher accuracy.

In the above-described embodiment, an operation program PG1 for executing the pressurizing force acquisition operation FO (steps S4 to S7) may be prepared separately from the welding work program 200. In this case, upon determining YES in step S3, the processor 50 executes the operation program PG1 and executes steps S4 to S7 as the pressurizing force acquisition operation FO.

Note that, in the above-described embodiment, a case is described where the flag FL is set for the controller 18. However, the present invention is not limited thereto, and in the welding work program 200 acquired in step S1, the flag FL for executing the pressurizing force acquisition operation FO instead may be assigned to the code: “GUN [ON] CONDITION [1]” of each welding instruction IN_{W}. Then, the processor 50 may refer to the flag FL assigned to the welding instruction IN_{W} read upon determining YES in step S3, and execute steps S4 to S7 as the pressurizing force acquisition operation FO instead of the welding instruction IN_{W}.

When the welding work program 200 is executed in order to execute the actual welding work, the flag FL may be deleted from the welding work program 200. Alternatively, the processor 50 may execute the welding instruction IN_{W} by ignoring the assigned flag FL during execution of the welding instruction IN_{W} in the welding work program 200.

In the above-described embodiment, a case is described where the pressurizing force sensor 16 is connected to the I/O interface 54 of the controller 18 and supplies the measured pressurizing force F to the controller 18. However, the present invention is not limited thereto, and the pressurizing force sensor 16 may not be connected to the controller 18. In this case, the operator may manually input the pressurizing force F measured by the pressurizing force sensor 16 at the end of the above-described step S5 to the controller 18 by operating the input device 58.

In the above-described embodiment, a case is described where the welding robot system 10 includes the pressurizing force sensor 16 independent of the welding gun 14, and the operator manually sets the pressurizing force sensor 16. However, the pressurizing force sensor 16 may be integrated with the welding gun 14.

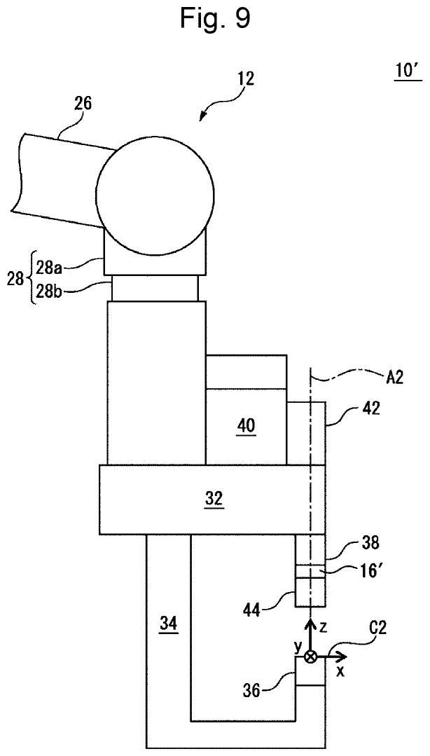

Such an embodiment is illustrated in FIG. 9. In a welding robot system 10′ illustrated in FIG. 9, a pressurizing force sensor 16′ is integrally fixed to the movable arm 38 together with the movable welding tip 44. When the movable welding tip 44 driven by the servomotor 40 pressurizes the pressurization target object (e.g., the fixed welding tip 36), the pressurizing force sensor 16′ detects a force acting on the pressurizing force sensor 16 as the reaction force, thereby measuring the pressurizing force F applied to the pressurization target object.

According to the welding robot system 10′, step S4 can be omitted from the flow in FIG. 5. Specifically, upon determining YES in step S3, the processor 50 executes step S5 to drive the servomotor 40 of the welding gun 14 according to the pressurizing force command F_{C_1}. As a result, the movable welding tip 44 is pressed against the fixed welding tip 36 as the pressurization target object, and thus pressurizes the fixed welding tip 36. Then, when the feedback FB1 acquired from the above-described load detection sensor LS reaches a value corresponding to the pressurizing force command F_{C_1}, the processor 50 stops the servomotor 40.

When this step S5 is executed, the pressurization target object (such as a steel plate) separate from the welding gun 14 may be inserted between the movable welding tip 44 and the fixed welding tip 36, and the pressurization target object may be pressurized by the movable welding tip 44. In step S6, the processor 50 acquires the pressurizing force F measured by the pressurizing force sensor 16′ at this time. The pressurizing force sensor 16′ may be fixed between the fixed welding tip 36 and the fixed arm 34.

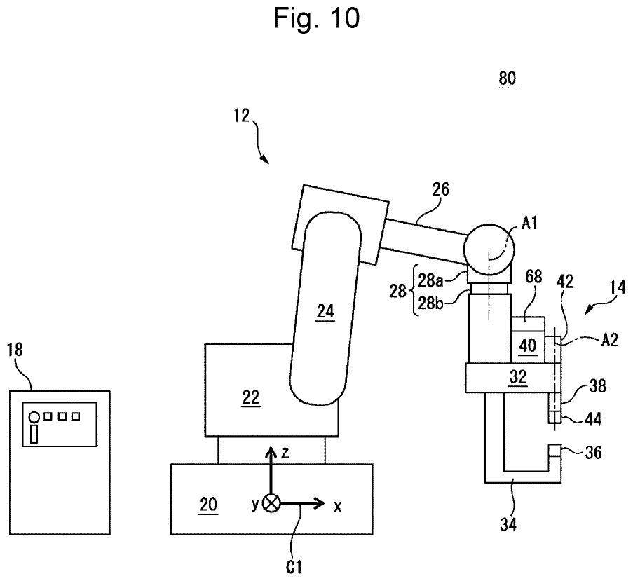

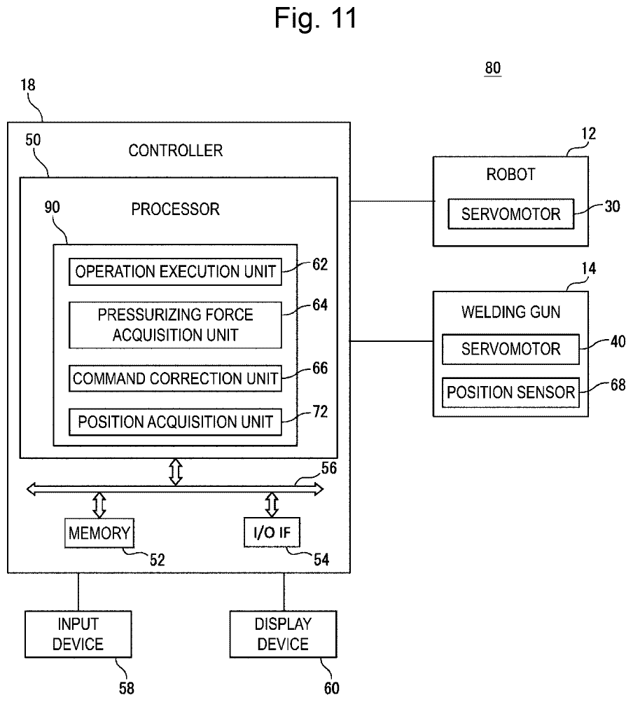

Next, with reference to FIGS. 10 and 11, a welding robot system 80 according to another embodiment is described. The welding robot system 80 differs from the welding robot system 10 described above in the following configuration. Specifically, in the welding robot system 80, the pressurizing force sensor 16 described above is not provided, and the welding gun 14 includes a position sensor 68.

The position sensor 68 detects a position PS of the movable welding tip 44. As an example, the position sensor 68 includes a rotation detection sensor RS2 (an encoder, a Hall sensor, or the like) provided to the servomotor 40 of the welding gun 14, and detects a rotational position (or a rotational angle) of the servomotor 40. Since the rotational position of the servomotor 40 is correlated with the positions of the movable arm 38 and the movable welding tip 44 in the direction of the gun axis A2, the position sensor 68 of the present example can detect the position PS of the movable welding tip 44 by detecting the rotational position of the servomotor 40.

As another example, the position sensor 68 includes a linear scale SC that is provided on the welding gun 14 (e.g., the base part 32) and enables direct detection of the position PS of the movable arm 38 or the movable welding tip 44 in the direction of the gun axis A2. The position sensor 68 (rotation detection sensor RS2 or linear scale SC) supplies detection data of the detected position PS to the controller 18.

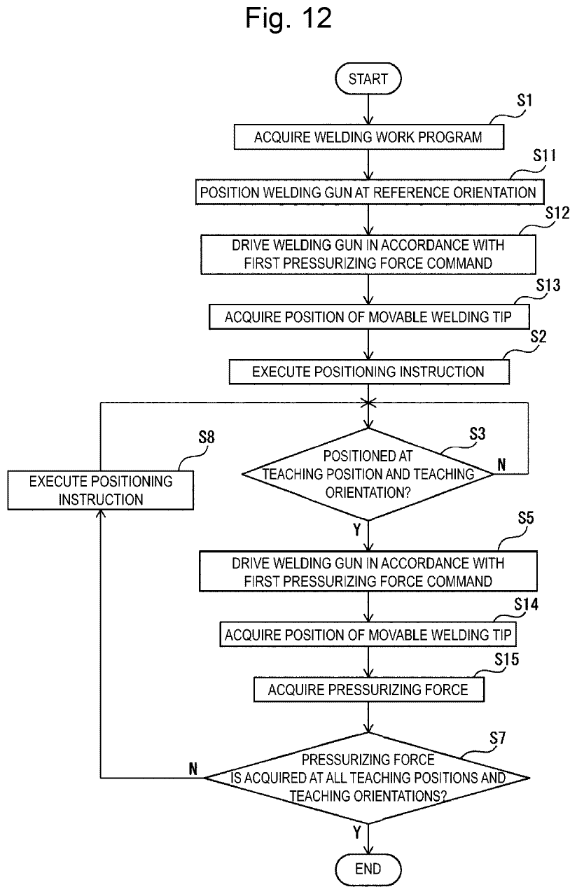

Next, a method of correcting the pressurizing force command F_{C} in the welding robot system 80 will be described with reference to FIG. 12. Note that in the flow illustrated in FIG. 12, the same processing as in the flow in FIG. 5 is denoted by the same step numbers, and redundant descriptions are omitted. After starting the flow illustrated in FIG. 12, the processor 50 executes step S1, and acquires the welding work program 200.

In the present embodiment, the processor 50 analyzes the acquired welding work program 200 and refers to the code “CONDITION [1]” in the welding instruction IN_{W} in the 2ith line. Then, the processor 50 acquires information on the pressurizing force F₁ (=2 [kN]) included in the welding condition 1 to which the identifier [1] in the code is assigned from the data table (FIG. 8) corresponding to the welding condition 1.

After step S1, in step S11, the processor 50 positions the welding gun 14 at the reference orientation OR₀. Specifically, the processor 50 operates the robot 12 to position the welding gun 14 at the reference orientation OR₀ illustrated in FIG. 3. As a result, the gun axis A2 of the welding gun 14 becomes parallel to the vertical direction, and the movable welding tip 44 is aligned vertically above the fixed welding tip 36.

In step S12, the processor 50 drives the welding gun 14 according to the pressurizing force command F_{C_m} (first pressurizing force command) corresponding to the pressurizing force Fₘ defined in the welding condition m. Specifically, the processor 50 generates the pressurizing force command F_{C_1} (=2 [kN]) corresponding to the pressurizing force F₁ based on the information on the pressurizing force F₁ included in the welding condition 1 acquired in step S1 described above, and drives the servomotor 40 of the welding gun 14 according to the pressurizing force command F_{C_1}.

Thus, the movable welding tip 44 is pressed against the fixed welding tip 36 as the pressurization target object. Then, when the feedback FB1 from the above-described load detection sensor LS reaches a value corresponding to the pressurizing force command F_{C_1}, the processor 50 stops the servomotor 40. As a result, the pressurizing force F₁ is applied from the movable welding tip 44 to the pressurizing force sensor 16.

Here, with the calibration work described above, the pressurizing force command F_{C} and the pressurizing force F at the time when the welding gun 14 arranged at the reference orientation OR₀ is driven in accordance with the pressurizing force command F_{C} are calibrated to match. Therefore, the pressurizing force F applied to the pressurizing force sensor 16 in this step S12 matches the pressurizing force F₁ (=2 [kN]) in the welding condition 1 corresponding to the pressurizing force command F_{C_1}.

In step S13, the processor 50 acquires a first position PS₁ of the movable welding tip 44. Specifically, the processor 50 acquires the first position PS₁ (or the rotational position) detected by the position sensor 68 at the end of step S12 (i.e., when the servomotor 40 is stopped) from the position sensor 68.

As described above, in the present embodiment, the processor 50 functions as a position acquisition unit 72 (FIG. 11) that acquires the first position PS₁ detected by the position sensor 68 when the welding gun 14 positioned at the reference orientation OR₀ is driven in accordance with the first pressurizing force command F_{C_1} and the pressurization target object (specifically, the fixed welding tip 36) is pressed by the movable welding tip 44.

After step S13, the processor 50 sequentially executes the above-described steps S2, S3, and S5. As a result, the welding gun 14 positioned at the nth teaching position TPₙ and at the nth teaching orientation ORₙ is driven according to the pressurizing force command F_{C_1} (=2 [kN]), and the movable welding tip 44 pressurizes the fixed welding tip 36 as the pressurization target object with the pressurizing force F. The pressurizing force F at this time may be different from the pressurizing force command F_{C_1} (that is, the pressurizing force F₁=2 [kN] in the welding condition 1) in accordance with the nth teaching orientation ORₙ.

In step S14, the processor 50 functions as the position acquisition unit 72, and acquires a second position PS₂ of the movable welding tip 44. Specifically, the processor 50 acquires the second position PS₂ (or the rotational position) detected by the position sensor 68 at the end of step S5 (i.e., when the servomotor 40 is stopped) from the position sensor 68.

As described above, the pressurizing force F with which the movable welding tip 44 pressurizes the fixed welding tip 36 when step S14 is performed may be different from the pressurizing force F₁ when step S13 is performed. Thus, the second position PS₂ acquired in step S14 may be different from the first position PS₁ acquired in step S13.

As described above, the processor 50 functions as the position acquisition unit 72 to obtain the second position PS₂ detected by the position sensor 68 when the pressurization target object (specifically, the fixed welding tip 36) is pressurized by the movable welding tip 44 with the welding gun 14, positioned at the nth teaching orientation ORₙ in step S2 or S8, driven in accordance with the first pressurizing force command F_{C_1}.

In step S15, the processor 50 functions as the pressurizing force acquisition unit 64, and acquires the pressurizing force F. Here, the first position PS₁ acquired in step S13, the second position PS₂ acquired in step S14, the pressurizing force F₁ defined in the welding condition 1 acquired in step S1, and the pressurizing force F acquired in step S15 are in a relationship represented by the following Formula 1:

$${PS}_{1} / {PS}_{2} = {F}_{1} / F . \qquad ( Formula 1 )$$

As a result of the above-described calibration work, the pressurizing force F₁ in Formula 1 matches the pressurizing force command F_{C_1}=2 [kN] as described above and is known. Therefore, from Formula 1, the pressurizing force F can be obtained by the following calculation: F=F₁·PS₂/PS₁. The processor 50 stores the obtained pressurizing force F in the memory 52.

After step S15, the processor 50 sequentially executes the above-described steps S7 and S8, and repeatedly executes a loop of steps S3, S5, S14, S15, S7, and S8 until determining YES in Step S7, and acquires the pressurizing force F in step S15 each time the welding gun 14 is positioned at the nth teaching position TPₙ and the nth teaching orientation ORₙ in step S8.

After finishing the flow illustrated in FIG. 12, the processor 50 executes the welding work program 200 for the actual welding work as in the above-described embodiment, and functions as the command correction unit 66 during the execution of the welding work program 200 to correct the pressurizing force command F_{C_1} at each teaching orientation ORₙ based on the pressurizing force F acquired in step S15, thereby obtaining the pressurizing force command F_{C_1}′.

As described above, in the present embodiment, the processor 50 corrects the pressurizing force command F_{C} in accordance with the orientation OR of the welding gun 14 by functioning as the operation execution unit 62, the pressurizing force acquisition unit 64, the command correction unit 66, and the position acquisition unit 72. Therefore, the operation execution unit 62, the pressurizing force acquisition unit 64, the command correction unit 66, and the position acquisition unit 72 form a device 90 (FIG. 11) that corrects the pressurizing force command F_{C} in accordance with the orientation OR of the welding gun 14.

In the device 90, the position acquisition unit 72 acquires the first position PS₁ detected by the position sensor 68 when the welding gun 14 positioned at the reference orientation OR₀ is driven in accordance with the first pressurizing force command F_{C_1} and the pressurization target object (fixed welding tip 36) is pressurized by the movable welding tip 44 (step S13).

The position acquisition unit 72 acquires the second position PS₂ detected by the position sensor 68 when the pressurization target object is pressurized by the movable welding tip 44 with the welding gun 14 positioned at the nth teaching orientation ORₙ by the operation execution unit 62 driven in accordance with the first pressurizing force command F_{C_1} (step S14). Then, based on the first position PS₁ and the second position PS₂, the pressurizing force acquisition unit 64 acquires the pressurizing force F at the nth teaching orientation ORₙ through a predetermined calculation (specifically, a calculation using the above-described Formula (1)) (step S15).

With this configuration, the pressurizing force F at the teaching orientation ORₙ can be acquired without using a physical sensor such as the pressurizing force sensor 16 described above. Therefore, the operator can omit the work of manually setting the pressurizing force sensor 16, and the flow in FIG. 12 can be effectively automated, whereby the work of acquiring the pressurizing force F can be simplified.

In the above-described embodiment, a case is described where the processor 50 positions the welding gun 14 at all the teaching positions TPₙ and the teaching orientations ORₙ by executing step S2 or S8, and acquires the pressurizing force F in step S6 or S15. However, the present invention is not limited thereto, and when the processor 50 functions as the command correction unit 66 to obtain the pressurizing force command F_{C_1}′ at the nth teaching position TPₙ and the nth teaching orientation ORₙ, the processor 50 can estimate the pressurizing force command F_{C_1}′ at a kth teaching position TPₖ and a kth teaching orientation ORₖ based on the obtained pressurizing force command F_{C_1}′, the nth teaching position TPₙ and the kth (k≠n) teaching position TPₖ.

For example, the processor 50 positions the welding gun 14 at the first teaching position TP1 and the teaching orientation OR₁ in step S2, and acquires the pressurizing force F in step S6 or S15 described above. It is assumed that the processor 50 then obtains the pressurizing force command F_{C_1}′ at the first teaching position TP1 and the first teaching orientation OR₁ by correcting the first pressurizing force command F_{C_1} based on the acquired pressurizing force F during the actual welding work.

In this case, the processor 50 can estimate the second pressurizing force command F_{C_1}′ at the second teaching position TP2 and at the second teaching orientation OR₂ by executing a predetermined calculation using a predetermined approximate formula based on the obtained pressurizing force command F_{C_1}′ and the first teaching position TP1 and the second teaching position TP2 defined in the welding work program 200 (specifically, coordinates in the robot coordinate system C1). This approximate formula is, for example, a formula representing a change (e.g., a linear change) in the pressurizing force F from the first teaching position TP1 to the second teaching position TP2, and is determined in advance by the operator.

In this case, the processor 50 functioning as the operation execution unit 62 does not execute the operation of positioning the welding gun 14 at the second teaching position TP2 and the second teaching orientation OR₂ in step S8 described above. With this configuration, the positioning operation in step S8 and the operation of acquiring the pressurizing force F in step S15 can be canceled for the second teaching orientation OR₂, and the second pressurizing force command F_{C_1}′ at the second teaching orientation OR₂ can be estimated with high accuracy.

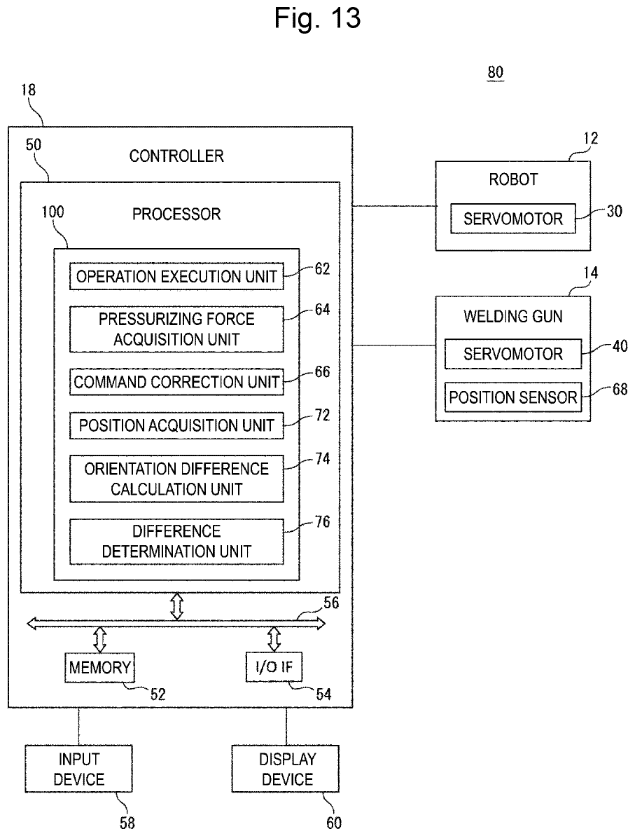

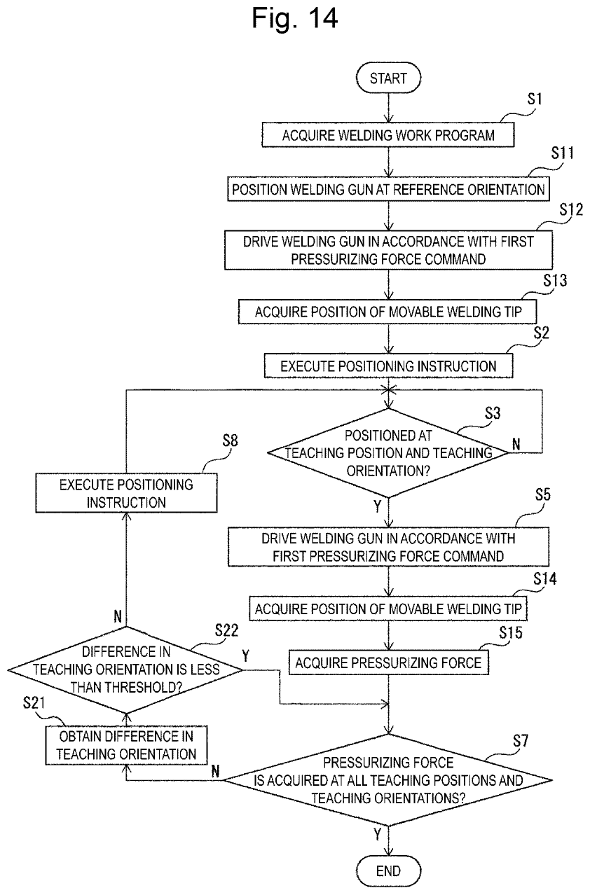

Next, other functions of the welding robot system 80 will be described with reference to FIGS. 13 and 14. The welding robot system 80 further executes a flow illustrated in FIG. 14. Note that in a flow illustrated in FIG. 14, the same processing as in the flow illustrated in FIG. 12 is denoted by the same step numbers, and redundant descriptions are omitted.

In the flow in FIG. 14, the processor 50 executes step S21 upon determining NO in step S7. In step S21, the processor 50 obtains a difference φ between the teaching orientation OR₁, OR₂, . . . , ORₙ defined in the positioning instruction IN_{P} that has already been executed and a teaching orientation ORₙ+1 defined in the positioning instruction IN_{P} to be executed next.

For example, it is assumed that the processor 50 positions the welding gun 14 at the first teaching position TP₁ and the first teaching orientation OR₁ in accordance with the positioning instruction IN_{P} in the first line in the welding work program 200 (FIG. 6) in step S2, then executes steps S3, S5, S14, S15, and S7, and proceeds to step S21.

In this case, in step S21, the processor 50 obtains a difference φ_{1_2} between the first teaching orientation OR₁ defined in the positioning instruction IN_{P} in the first line and the second teaching orientation OR₂ defined in the positioning instruction IN_{P} in the third line to be executed next. Specifically, the processor 50 refers to the code of the positioning instruction IN_{P}: “MOVE [TP2] VELOCITY [V2]” in the third line in the welding work program 200, and acquires the coordinates (X₂, Y₂, Z₂, W₂, P₂, R₂) indicated by the identifier “TP2” from the position data table 202.

Then, based on the coordinates (W₁, P₁, R₁) of the first teaching orientation OR₁ defined in the positioning instruction IN_{P} of the first line executed most recently and the coordinates (W₂, P₂, R₂) of the second teaching orientation OR₂ acquired from the position data table 202, the processor 50 obtains the difference φ_{1_2} between the first teaching orientation OR₁ and the second teaching orientation OR₂.

An example of the method of obtaining the difference φ_{1_2} will be described below. First, the processor 50 expresses the coordinates (W₁, P₁, R₁) of the first teaching orientation OR₁ as a 3×3 matrix M₁. In this matrix M₁, a vector V_{1_1} represented by three parameters in a first column is a unit vector representing the rotation component around the x axis of the tool coordinate system C2, a vector V_{1_2} represented by three parameters in a second column is a unit vector representing the rotation component around the y axis of the tool coordinate system C2, and a vector V_{1_3} represented by three parameters in a third column is a unit vector representing the rotation component around the z axis of the tool coordinate system C2.

Similarly, the processor 50 expresses the coordinates (W₂, P₂, R₂) of the second teaching orientation OR₂ as a 3×3 matrix M₂. Then, the processor 50 obtains an inner product IP₁ of the vector V_{1_1} in the first column of the matrix M₁ and a vector V_{2_1} in the first column of the matrix M₂. The inner product IP₁ is expressed as cos φₓ when it is assumed that φₓ is the angle between the vector V_{1_1} and the vector V_{2_1}. The angle φₓ represents a difference φ_{1_2} between the first teaching orientation OR₁ and the second teaching orientation OR₂ in the direction around the x axis of the tool coordinate system C2. The processor 50 can determine the angle φₓ=cos⁻¹ (IP₁) from the determined inner product IP₁=cos Φₓ.

Similarly, the processor 50 obtains an inner product IP₂ of the vector V_{1_2} in the second column of the matrix M₁ and a vector V_{2_2} in the second column of the matrix M₂. The inner product IP₂ is expressed as cos φ_{y} when it is assumed that φ_{y} is the angle between the vector V_{1_2} and the vector V_{2_2}. The angle φ_{y} represents a difference φ_{1_2} between the first teaching orientation OR₁ and the second teaching orientation OR₂ in the direction around the y axis of the tool coordinate system C2. The processor 50 can obtain the angle φ_{y}=cos⁻¹ (IP₂) from the determined inner product IP₂=cos φ_{y}.

In this way, the processor 50 obtains the angles φₓ and φ_{y} as the difference φ_{1_2} between the first teaching orientation OR₁ and the second teaching orientation OR₂. Therefore, the processor 50 functions as an orientation difference calculation unit 74 (FIG. 13) that calculates the difference φ_{1_2} between the first teaching orientation OR₁ and the second teaching orientation OR₂. Note that the method of obtaining the difference φ described above is an example, and the processor 50 may obtain the difference φ using any method.

In step S22, the processor 50 determines whether the difference φ estimated in step S21 is smaller than a predetermined threshold φₜₕ. For example, it is assumed that the processor 50 obtains the angles φₓ and φ_{y} as the difference φ_{1_2} between the first teaching orientation OR₁ and the second teaching orientation OR₂ in the immediately previous step S21.

In this case, the processor 50 determines in this step S22 whether or not the angle φₓ is smaller than a predetermined threshold φ_{th_x} (i.e., φₓ<φ_{th_x}) and whether or not the angle φ_{y} is smaller than a predetermined threshold φ_{th_y} (i.e., φ_{y}<φ_{th_y}). When φₓ<φ_{th_x} and φ_{y}<φ_{th_y} hold, the processor 50 determines that the difference φ_{1_2} between the first teaching orientation OR₁ and the second teaching orientation OR₂ is smaller than the threshold φₜₕ (that is, YES). On the other hand, when φₓ≥φ_{th_x} or φ_{y}≥φ_{th_y} hold, the processor 50 determines that the difference φ_{1_2} between the first teaching orientation OR₁ and the second teaching orientation OR₂ is equal to or larger than the threshold φₜₕ (i.e., determines NO).

As described above, in the present embodiment, the processor 50 functions as a difference determination unit 76 (FIG. 13) that determines whether or not the difference φ_{1_2} obtained in step S21 is smaller than the predetermined threshold φₜₕ. On the other hand, upon determining NO in step S22, the processor 50 proceeds to step S8. Then, in step S8, the processor 50 executes the positioning instruction IN_{P} in the third line to move the welding gun 14 to the second teaching position TP2 and the second teaching orientation OR₂, and returns to step S3.

On the other hand, when determining YES in step S22, the processor 50 returns to step S7. That is, in the present embodiment, when the difference φ_{1_2} between the first teaching orientation OR₁ and the second teaching orientation OR₂ is small (in other words, when the two orientations OR₁ and OR₂ are approximate to each other), the processor 50 does not execute the operation of executing the positioning instruction IN_{P} in the third line in step S8 and the subsequent operation of acquiring the pressurizing force F at the second teaching position TP2 and the second teaching orientation OR₂ in step S15. Then, in step S7, the processor 50 determines that the pressurizing force F is acquired for the second teaching position TP2 and the teaching orientation OR₂.

As described above, in the present embodiment, when the difference φ between at least one of the teaching orientations OR₁, OR₂, . . . , ORₙ defined in the already executed positioning instruction IN_{P} and the teaching orientation ORₙ₊₁ defined in the positioning instruction IN_{P} to be executed next is small, the next positioning instruction IN_{P} is not executed and the operation of acquiring the pressurizing force F is canceled.

For example, it is assumed that the difference φ_{1_2} between the first teaching orientation OR₁ and the second teaching orientation OR₂ among the four teaching orientations ORₙ illustrated in FIG. 7 is smaller than the threshold φₜₕ as described above. In this case, it is assumed that the processor 50 positions the welding gun 14 at the third teaching position TP3 and the teaching orientation OR₃ in accordance with the positioning instruction IN_{P} in the fifth line in the welding work program 200 in step S8, then executes steps S3, S5, S14, S15, and S7, and proceeds to step S21.

In this case, in step S21, the processor 50 obtains each of a difference φ_{1_4} between the first teaching orientation OR₁ defined in the already executed first line positioning instruction IN_{P} and a fourth teaching orientation OR₄ specified in the seventh line positioning instruction IN_{P} to be executed next, and a difference φ_{3_4} between the third teaching orientation OR₃ defined in the already executed third line positioning instruction IN_{P} and the fourth teaching orientation OR₄.

In step S22, when at least one of the differences φ_{1_4} and φ_{3_4} is smaller than the threshold φₜₕ, the processor 50 determines YES. In this case, the processor 50 does not execute the positioning instruction IN_{P} in the seventh line, and cancels step S15 of acquiring the pressurizing force F at the fourth teaching orientation OR₄. That is, in the present embodiment, the processor 50 acquires the pressurizing force F in step S15 only for the teaching orientations ORₙ which are not approximate to each other (that is, the difference φ is equal to or greater than the predetermined threshold φₜₕ).

After the flow in FIG. 14, the processor 50 executes the welding work program 200 for the actual welding work, and functions as the command correction unit 66 during the execution of the welding work program 200 to correct the pressurizing force command F_{C_1} at each teaching orientation ORₙ based on the pressurizing force F acquired in step S15, thereby obtaining the pressurizing force command F_{C_1}′.

Here, in the present embodiment, the processor 50 uses the common correction amount ΔF between a plurality of teaching orientations ORₙ with a small difference φ(that is, approximate to each other). For example, it is assumed that the operation of acquiring the pressurizing force F in step S15 is canceled because the difference φ_{1_2} between the first teaching orientation OR₁ and the second teaching orientation OR₂ is small and it is determined YES in step S22.

In this case, the processor 50 functions as the command correction unit 66 and corrects the pressurizing force command F_{C_1} for driving the welding gun 14 at the second teaching orientation OR₂ using the correction amount ΔF obtained for the first teaching orientation OR₁. For example, it is assumed that the correction amount ΔF obtained at the first teaching orientation OR₁ is ΔF=0.5 [kN] as described above.

In this case, when the welding instruction IN_{W} in the fourth line in the welding work program 200 is executed, the processor 50 corrects the pressurizing force command F_{C_1} (=2 [kN]) for driving the welding gun 14 at the second teaching orientation OR₂ by the correction amount ΔF (=0.5 [kN]) obtained at the first teaching orientation OR₁ to obtain the new pressurizing force command F_{C_1}′=2.5 [kN] (second pressurizing force command). When the welding instruction IN_{W} in the fourth line is executed, the processor 50 drives the welding gun 14 positioned at the second teaching orientation OR₂ with the new pressurizing force command F_{C_1}′ (=2.5 [kN]).

For example, it is assumed that the operation of acquiring the pressurizing force F in step S15 is canceled because the difference φ_{1_4} between the first teaching orientation OR₁ and the fourth teaching orientation OR₄ is small and it is determined YES in step S22. In this case, the processor 50 functions as the command correction unit 66 and corrects the pressurizing force command F_{C} for driving the welding gun 14 at the fourth teaching orientation OR₄ by using the correction amount ΔF (=0.5 [kN]) obtained for the first teaching orientation OR₁ to obtain the new pressurizing force command F_{C_1}′ (=2.5 [kN]).

Then, when the welding instruction IN_{W} in the eighth line is executed, the processor 50 drives the welding gun 14 positioned at the fourth teaching orientation OR₄ in accordance with the new pressurizing force command F_{C_1}′. That is, in this case, the processor 50 corrects the original pressurizing force command F_{C_1} using the common correction amount ΔF (=0.5 [kN]) at the first teaching orientation OR₁, the second teaching orientation OR₂, and the fourth teaching orientation OR₄.

In the present embodiment, a case is described where the pressurizing force command F_{C_1} having the same value (that is, the pressurizing force F₁=2 [kN] of the welding condition 1 illustrated in FIG. 8) is determined in advance at all the teaching orientations ORₙ. However, the present invention is not limited thereto, and a different pressurizing force command F_{C_1} may be determined for each teaching orientation ORₙ. In this case, the pressurizing force command F_{C_1} for each teaching orientation ORₙ may be stored in the data table of the welding condition 1 illustrated in FIG. 8.

As described above, in the present embodiment, the processor 50 corrects the pressurizing force command F_{C} in accordance with the orientation OR of the welding gun 14 by functioning as the operation execution unit 62, the pressurizing force acquisition unit 64, the command correction unit 66, the position acquisition unit 72, the orientation difference calculation unit 74, and the difference determination unit 76. Therefore, the operation execution unit 62, the pressurizing force acquisition unit 64, the command correction unit 66, the position acquisition unit 72, the orientation difference calculation unit 74, and the difference determination unit 76 form a device 100 (FIG. 13) that corrects the pressurizing force command F_{C} in accordance with the orientation OR of the welding gun 14.

In the device 100, the pressurizing force acquisition unit 64 acquires the first pressurizing force F when the welding gun 14 is positioned at the first teaching orientation OR₁ by the operation execution unit 62 (step S15), and the command correction unit 66 calculates the correction amount ΔF (=0.5 [kN]) for correcting the first pressurizing force command F_{C_1} (=2 [kN]) for driving the welding gun 14 at the first teaching orientation OR₁, to the second pressurizing force command F_{C_1}′ (=2.5 [kN]) based on the first pressurizing force F.

On the other hand, the orientation difference calculation unit 74 calculates the difference φ_{1_2} between the first teaching orientation OR₁ and the second teaching orientation OR₂ (step S21), and the difference determination unit 76 determines whether or not the difference φ_{1_2} calculated by the orientation difference calculation unit 74 is smaller than the predetermined threshold φₜₕ (step S22). When the difference determination unit 76 determines that the difference φ_{1_2} is smaller than the predetermined threshold φₜₕ (i.e., YES in step S22), the operation execution unit 62 does not execute the operation (step S8) of positioning the welding gun 14 at the second teaching orientation OR₂.

Then, the command correction unit 66 corrects the first pressurizing force command F_{C} (=2 [kN]) for driving the welding gun 14 at the second teaching orientation OR₂ using the correction amount ΔF obtained at the first teaching orientation OR₁, thereby obtaining the second pressurizing force command F_{C_1}′ (=2.5 [kN]) at the second teaching orientation OR₂.

According to this configuration, since the common correction amount ΔF can be used between a plurality of teaching orientations ORₙ with a small difference φ, it is possible to cancel the positioning operation in step S8 and the operation of acquiring the pressurizing force F in step S15. With this configuration, the cycle time of the flow in FIG. 14 can be reduced.

The difference determination unit 76 and the orientation difference calculation unit 74 of the device 100 may be applied to the device 70 illustrated in FIG. 2. The processor 50 executes steps S21 and S22 in FIG. 14 upon determining NO in step S7 in FIG. 5, and returns to step S7 and proceeds to step S8 upon determining YES and NO respectively in step S22.

Here, in the present embodiment, a case is described where the processor 50 uses the common correction amount ΔF between a plurality of teaching orientations ORₙ with a small difference φ (that is, approximate to each other). However, the present invention is not limited thereto, and when there are a plurality of teaching orientations ORₙ with a small difference φ, the processor 50 may obtain the second pressurizing force command F_{C_1}′ at another teaching orientation ORₙ₊₁ based on the second pressurizing force command F_{C_1}′ corrected at one teaching orientation ORₙ and the difference φ.

For example, it is assumed that the processor 50 obtains the second pressurizing force command F_{C_1}′ by correcting the first pressurizing force command F_{C_1} at the first teaching orientation OR₁ as described above, and the difference φ_{1_2} between the first teaching orientation OR₁ and the second teaching orientation OR₂ (that is, the angles φₓ and φ_{y}) is small. In this case, the processor 50 may obtain the second pressurizing force command F_{C_1}′ at the second teaching orientation OR₂ by linearly changing the second pressurizing force command F_{C_1}′ at the first teaching orientation OR₁ in accordance with the angle φ_{y} around the y axis of the tool coordinate system C2 orthogonal to the gun axis A2 in the difference φ_{1_2}.

For example, it is assumed that the second teaching orientation OR₂ is the orientation illustrated in FIG. 4, and the first teaching orientation OR₁ is an orientation obtained by rotating the second teaching orientation OR₂ by the angle φ_{y} around the y axis of the tool coordinate system C2, to the orientation illustrated in FIG. 3. In this case, the processor 50 may function as the command correction unit 66 to obtain the second pressurizing force command F_{C_1}′ at the second teaching orientation OR₂ by linearly increasing the second pressurizing force command F_{C_1}′ at the first teaching orientation OR₁ in accordance with the angle φ_{y}.

On the contrary, it is assumed that the first teaching orientation OR₁ is the orientation illustrated in FIG. 4, and the second teaching orientation OR₂ is an orientation obtained by rotating the first teaching orientation OR₁ by the angle φ_{y} around the y axis of the tool coordinate system C2, toward the orientation illustrated in FIG. 3. In this case, the processor 50 may function as the command correction unit 66 to obtain the second pressurizing force command F_{C_1}′ at the second teaching orientation OR₂ by linearly increasing the second pressurizing force command F_{C_1}′ at the first teaching orientation OR₁ in accordance with the angle φ_{y}.

As described above, in the present embodiment, the command correction unit 66 obtains the second pressurizing force command F_{C_1}′ at the second teaching orientation OR₂ based on the second pressurizing force command F_{C_1}′ at the first teaching orientation OR₁ and the difference φ(e.g., the angle φ_{y}). With this configuration, the positioning operation in step S8 and the operation of acquiring the pressurizing force F in step S15 can be canceled for the second teaching orientation OR₂, and the second pressurizing force command F_{C_1}′ at the second teaching orientation OR₂ can be obtained with high accuracy in accordance with the difference φ.

When there are a plurality of teaching orientations ORₙ with a small difference φ, the processor 50 may obtain the correction amount ΔF at another teaching orientation ORₙ+1 based on the correction amount ΔF obtained at one teaching orientation ORₙ and the difference φ. For example, it is assumed that the correction amount ΔF is obtained at the first teaching orientation OR₁ as described above and the difference φ_{1_2} between the first teaching orientation OR₁ and the second teaching orientation OR₂ is small. In this case, the processor 50 may obtain the correction amount ΔF for correcting the first pressurizing force command F_{C_1} at the second teaching orientation OR₂ by linearly changing the correction amount ΔF obtained at the first teaching orientation OR₁ in accordance with the angle φ_{y} around the y axis of the tool coordinate system C2 orthogonal to the gun axis A2.

For example, it is assumed that the second teaching orientation OR₂ is the orientation illustrated in FIG. 4, and the first teaching orientation OR₁ is an orientation obtained by rotating the second teaching orientation OR₂ by the angle φ_{y} around the y axis of the tool coordinate system C2, toward the orientation illustrated in FIG. 3. In this case, the processor 50 may function as the command correction unit 66 to obtain the correction amount ΔF for correcting the first pressurizing force command F_{C_1} at the second teaching orientation OR₂ by linearly increasing the correction amount ΔF at the first teaching orientation OR₁ in accordance with the angle φ_{y}.

On the contrary, it is assumed that the first teaching orientation OR₁ is the orientation illustrated in FIG. 4, and the second teaching orientation OR₂ is an orientation obtained by rotating the first teaching orientation OR₁ by the angle φ_{y} around the y axis of the tool coordinate system C2, toward the orientation illustrated in FIG. 3. In this case, the processor 50 may function as the command correction unit 66 to obtain the correction amount ΔF for correcting the first pressurizing force command F_{C_1} at the second teaching orientation OR₂ by linearly reducing the correction amount ΔF at the first teaching orientation OR₁ in accordance with the angle φ_{y}.

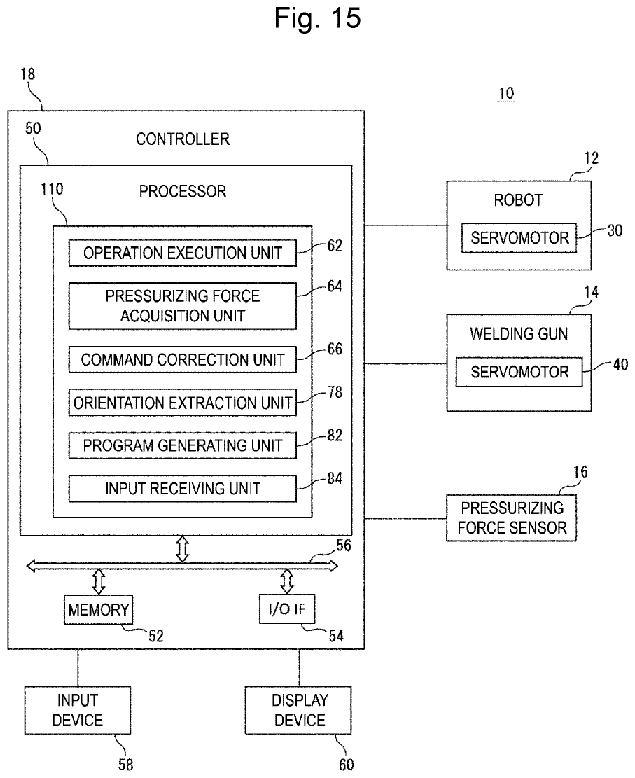

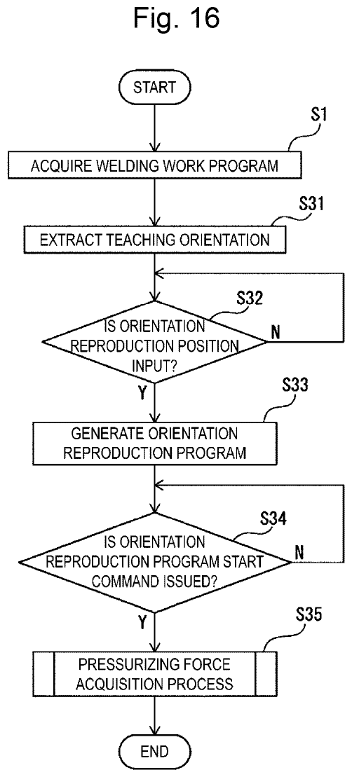

Next, other functions of the welding robot system 10 will be described with reference to FIGS. 15 to 17. The welding robot system 10 further executes a flow illustrated in FIG. 16. In the present embodiment, the processor 50 generates the orientation reproduction program 204 for reproducing each teaching orientation ORₙ defined in the welding work program 200 and acquiring the pressurizing force F at each teaching orientation ORₙ.

After starting the flow in FIG. 16, the processor 50 executes step S1, and acquires the welding work program 200. In step S31, the processor 50 extracts the teaching orientation ORₙ from the welding work program 200. Specifically, the processor 50 analyzes the welding work program 200 and extracts all the positioning instructions IN_{P} defined in the welding work program 200.

Then, the processor 50 extracts an identifier [TPₙ] included in the code of the positioning instruction IN_{P}, and acquires the teaching orientation ORₙ indicated by the identifier [TPₙ] from the position data table 202 (FIG. 7). As a result, the processor 50 extracts coordinates (W₁, P₁, R₁) representing the first teaching orientation OR₁, coordinates (W₂, P₂, R₂) representing the second teaching orientation OR₂, coordinates (W₃, P₃, R₃) representing the third teaching orientation OR₃, and coordinates (W₄, P₄, R₄) representing the fourth teaching orientation OR₄. In this way, in the present embodiment, the processor 50 functions as an orientation extraction unit 78 (FIG. 15) that extracts the teaching orientation ORₙ from the welding work program 200.

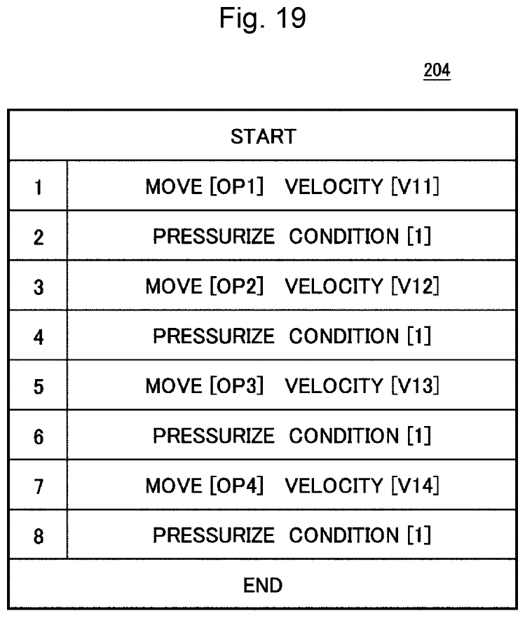

In step S32, the processor 50 determines whether or not an input of an orientation reproduction position OP is received. The orientation reproduction position OP is a position (specifically, coordinates (X, Y, Z)) in the robot coordinate system C1 for positioning the welding gun 14 (in other words, the TCP) at the time of execution of an orientation reproduction program 204 (FIG. 19) described later.

For example, the processor 50 generates an input image IM for inputting the orientation reproduction position OP, and makes the display device 60 display the image. While viewing the input image IM, the operator operates the input device 58 to provide an input for designating the coordinates of the orientation reproduction position OP to the processor 50. Hereinafter, a case where the operator designates the coordinates (X₀, Y₀, Z₀) in the robot coordinate system C1 as the orientation reproduction position OP will be described.

The coordinates (X₀, Y₀, Z₀) of the orientation reproduction position OP are designated by the operator as coordinates different from at least one (e.g., all of) the teaching position TPₙ (Xₙ, Yₙ, Zₙ) defined in the welding work program 200 and closer to the origin (that is, the robot base 20) of the robot coordinate system C1 than the at least one teaching position TPₙ.

The processor 50 proceeds to step S33 upon determining YES, that is, when the input of the orientation reproduction position OP is received from the operator, and repeats step S32 upon determining NO. Thus, in the present embodiment, the processor 50 functions as an input receiving unit 84 (FIG. 15) that receives the input of the orientation reproduction position OP different from the teaching position TPₙ.

In step S33, the processor 50 generates the orientation reproduction program 204 based on the teaching orientation ORₙ extracted in step S31. Specifically, the processor 50 first generates a position data table 206 for the orientation reproduction program 204 based on the teaching orientation ORₙ extracted in step S31 and the orientation reproduction position OP received in step S32.

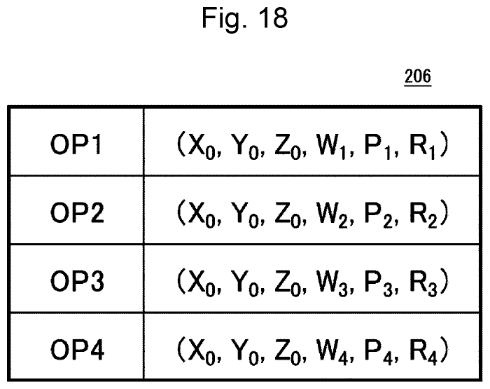

FIG. 18 illustrates an example of the position data table 206. In the position data table 206 illustrated in FIG. 18, the coordinate data pieces to which identifiers “OP1”, “OP2”, “OP3”, and “OP4” are respectively assigned are stored. As illustrated in FIG. 18, the coordinates of the identifiers “OPn” (n=1, 2, 3, 4) share the coordinates (X₀, Y₀, Z₀) of the orientation reproduction position OP received in step S32, and each includes the coordinates (Wₙ, Pₙ, Rₙ) of the teaching orientation ORₙ extracted in step S31. The processor 50 generates the position data table 206 as illustrated in FIG. 18 based on the teaching orientation ORₙ extracted in step S31 and the orientation reproduction position OP received in step S32.

Next, the processor 50 generates the orientation reproduction program 204 based on the generated position data table 206. FIG. 19 illustrates an example of the orientation reproduction program 204. In the orientation reproduction program 204 illustrated in FIG. 19, for example, a code “MOVE [OP3] VELOCITY [V13]” in the fifth line is a positioning instruction IN_{O} for moving the welding gun 14 by the robot 12 at a velocity V=V₁₃ [mm/sec] and positioning the welding gun 14 at the orientation reproduction position OP and the teaching orientation OR₃ indicated by the identifier [OP3].

The velocity Vₙ: “VELOCITY [Vn]” (n=11, 12, 13, 14) defined in the orientation reproduction program 204 may be set to be a velocity different from (specifically, lower than) the velocity Vₙ (n=1, 2, 3, 4) defined in the welding work program 200 (e.g., V₁₁=V₁₂=V₁₃=V₁₄<V₁=V₂=V₃=V₄).

When reading the positioning instruction IN_{O} in the fifth line during execution of the orientation reproduction program 204, the processor 50 acquires the coordinates (X₀, Y₀, Z₀, W₃, P₃, R₃) indicated by the identifier “OP3” from the position data table 206. Then, the processor 50 functions as the operation execution unit 62 and operates the robot 12 in the robot coordinate system C1 to position the welding gun 14 at the coordinates (X₀, Y₀, Z₀, W₃, P₃, R₃).

On the other hand, the code “PRESSURIZE CONDITION [1]” in the 2ith line (i=1, 2, 3, 4) of the orientation reproduction program 204 is a pressurization instruction INR for driving the servomotor 40 of the welding gun 14 according to the welding condition 1 to which the identifier [1] is assigned to cause the welding gun 14 to pressurize the pressurization target object. As described above, the orientation reproduction program 204 does not include the welding instruction IN_{W} defined in the welding work program 200.

Upon reading the pressurization instruction INR during execution of the orientation reproduction program 204, the processor 50 refers to the data table of the welding condition 1 to which the identifier [1] is assigned, acquires the pressurizing force F₁=2 [kN], and drives the servomotor 40 of the welding gun 14 according to the pressurizing force command F_{C_1} (=2 [kN]) corresponding to the pressurizing force F₁.

As described above, in the present embodiment, the processor 50 generates the position data table 206 based on the teaching orientation ORₙ extracted in step S31 and the orientation reproduction position OP received in step S32, and generates the orientation reproduction program 204 based on the position data table 206. Thus, the processor 50 functions as a program generating unit 82 (FIG. 15) that generates the orientation reproduction program 204 based on the teaching orientation ORₙ and the orientation reproduction position OP.

Referring back to FIG. 16, in step S34, the processor 50 determines whether or not an orientation reproduction program start command is received from the operator or the host controller. The processor 50 proceeds to step S35 upon determining YES, and repeats step S34 upon determining NO.

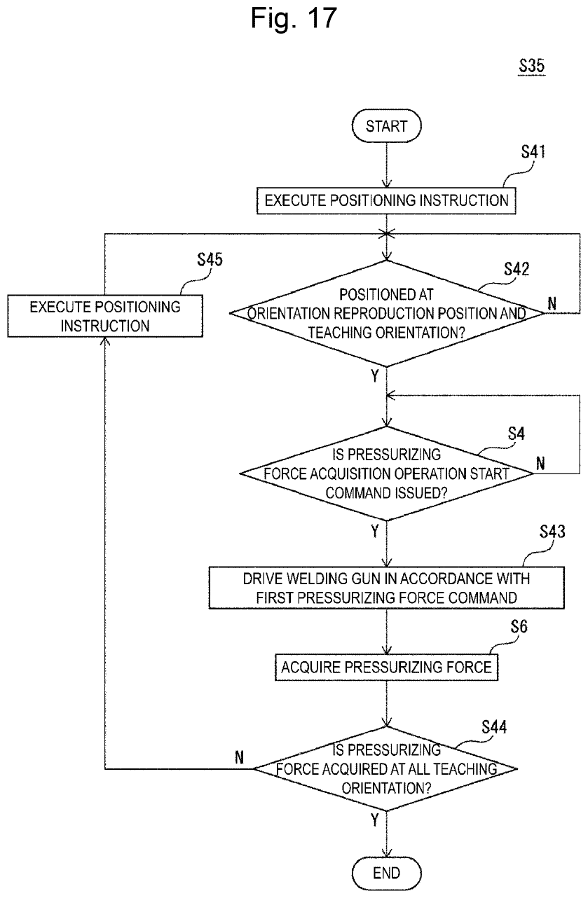

In step S35, the processor 50 executes a pressurizing force acquisition process. This step S35 will be described with reference to FIG. 17. Note that in the flow illustrated in FIG. 17, the same processing as in the flow in FIG. 5 is denoted by the same step numbers, and redundant descriptions are omitted.

In step S41, the processor 50 executes the positioning instruction IN_{O} in the orientation reproduction program 204. Specifically, the processor 50 functions as the operation execution unit 62 to read the positioning instruction IN_{O} “MOVE [OP1] VELOCITY [V11]” defined in the first line of the orientation reproduction program 204 and move the robot 12 at the velocity V₁₁ to position the welding gun 14 at the orientation reproduction position OP and the teaching orientation OR₁ (i.e., the coordinates (X₀, Y₀, Z₀, W₁, P₁, R₁) of the identifier “OP1”).

In step S42, the processor 50 determines whether or not the welding gun 14 is positioned at the orientation reproduction position OP and at the nth teaching orientation ORₙ (i.e., the coordinates (X₀, Y₀, Z₀, Wₙ, Pₙ, Rₙ) of the identifier “OPn”). Specifically, the processor 50 determines whether or not the welding gun 14 is positioned at the orientation reproduction position OP and at the nth teaching orientation ORₙ based on the feedback FB2 from the rotation detection sensor RS1.

Upon determining that the welding gun 14 is positioned at the orientation reproduction position OP and at the nth teaching orientation ORₙ (i.e., determining YES), the processor 50 stops the operation of the robot 12 and proceeds to step S4. As a result, the welding gun 14 stops while being positioned at the orientation reproduction position OP and at the nth teaching orientation ORₙ. On the other hand, upon determining NO, the processor 50 returns to step S42.

In step S43 after step S4, the processor 50 drives the welding gun 14 according to the pressurizing force command F_{C_m} (first pressurizing force command) corresponding to the pressurizing force Fₘ defined in the welding condition m. Specifically, the processor 50 reads the pressurization instruction INR in the 2ith line in the orientation reproduction program 204.

Then, in step S43, the processor 50 acquires the pressurizing force F₁ (=2 [kN]) defined in the welding condition 1 to which the identifier [1] is assigned in accordance with a code “CONDITION [1]” of the read pressurization instruction INR. Then, the processor 50 generates the pressurizing force command F_{C_1} (=2 [kN]) corresponding to the pressurizing force F₁ acquired from the welding condition 1, and drives the servomotor 40 of the welding gun 14 according to the pressurizing force command F_{C_1}.

Then, when the feedback FB1 from the above-described load detection sensor LS reaches a value corresponding to the pressurizing force command F_{C_1}, the processor 50 stops the servomotor 40. As a result, the pressurizing force sensor 16 is held between the movable welding tip 44 and the fixed welding tip 36. Next, the processor 50 executes step S6, functions as the pressurizing force acquisition unit 64, and acquires the pressurizing force F measured by the pressurizing force sensor 16 at the end of step S43 (that is, when the servomotor 40 is stopped) from the pressurizing force sensor 16.

In step S44, the processor 50 determines whether or not the pressurizing force F has been acquired for all the teaching orientations ORₙ defined in the orientation reproduction program 204. Upon determining YES, the processor 50 ends the flow illustrated in FIG. 17, and thus ends the flow in FIG. 16. On the other hand, upon determining NO, the processor 50 proceeds to step S45.

In step S45, the processor 50 executes the positioning instruction IN_{O} defined in the subsequent line in the orientation reproduction program 204. For example, when executing step S45 for the first time, the processor 50 executes a positioning instruction IN_{O} “MOVE [OP2] VELOCITY [V₁₂]” in the third line to move the welding gun 14 at a velocity V₁₂ so as to position the welding gun 14 at the orientation reproduction position OP and the second teaching orientation OR₂.

Then, the processor 50 returns to step S42. In this way, the processor 50 repeatedly executes the loop of steps S44, S4, S43, S6, S44, and S45 until determining YES in step S42, and acquires the pressurizing force F in step S45 each time the welding gun 14 is positioned at the orientation reproduction position OP and the nth teaching orientation ORₙ in step S6.

That is, according to the orientation reproduction program 204, the processor 50 executes steps S41 and S45 to change only the orientation of the welding gun 14 to the teaching orientation ORₙ without changing the position (i.e., the orientation reproduction position OP) of the welding gun 14 (i.e., while maintaining the orientation reproduction position OP), and acquires the pressurizing force F in step S6.

After ending the flow illustrated in FIG. 17, the processor 50 executes the welding work program 200 to perform the actual welding work on the workpiece. When the welding work program 200 is executed for the actual welding work, the processor 50 functions as the command correction unit 66 to correct the pressurizing force command F_{C_1} at each teaching orientation ORₙ based on the pressurizing force F acquired in step S6 of step S35, thereby obtaining the pressurizing force command F_{C_1}′.

As described above, in the present embodiment, the processor 50 corrects the pressurizing force command F_{C} in accordance with the orientation OR of the welding gun 14 by functioning as the operation execution unit 62, the pressurizing force acquisition unit 64, the command correction unit 66, the orientation extraction unit 78, the program generating unit 82, and the input receiving unit 84. Therefore, the operation execution unit 62, the pressurizing force acquisition unit 64, the command correction unit 66, the orientation extraction unit 78, the program generating unit 82, and the input receiving unit 84 form a device 110 (FIG. 15) that corrects the pressurizing force command F_{C} in accordance with the orientation OR of the welding gun 14.

In the device 110, the operation execution unit 62 executes the orientation reproduction program 204 including the positioning instruction IN_{O} for operating the robot 12 to position the welding gun 14 at the orientation reproduction position OP and the teaching orientation ORₙ different from the teaching position TPₙ but not including the welding instruction IN_{W}, thereby positioning the welding gun 14 at the orientation reproduction position OP and the teaching orientation ORₙ by the robot 12 (steps S41 and S45).

Then, the pressurizing force acquisition unit 64 acquires the pressurizing force F at the timing when the operation execution unit 62 positions the welding gun 14 at the orientation reproduction position OP and the teaching orientation ORₙ (step S6). With this configuration, by executing the orientation reproduction program 204 for reproducing the teaching orientation ORₙ defined in the welding work program 200, it is possible to position the welding gun 14 at the teaching orientation ORₙ and effectively acquire the pressurizing force F for correcting the pressurizing force command F_{C} at the teaching orientation ORₙ.

Further, in the device 110, the orientation extraction unit 78 extracts the teaching orientation ORₙ from the welding work program 200 (step S31), and the program generating unit 82 generates the orientation reproduction program 204 based on the teaching orientation ORₙ extracted by the orientation extraction unit 78. According to this configuration, since the computer can automatically generate the orientation reproduction program 204, the work of the operator can be reduced.

In addition, in the device 110, the input receiving unit 84 receives the input of the orientation reproduction position OP (step S32), and the program generating unit 82 generates the orientation reproduction program 204 further based on the orientation reproduction position OP received by the input receiving unit 84. According to this configuration, for example, the operator can arbitrarily designate the orientation reproduction position OP as coordinates close to the origin (the robot base 20) of the robot coordinate system C1. As a result, since the operation range of the robot 12 while the orientation reproduction program 204 is being executed can be reduced, the robot 12 can be reliably prevented from interfering with the peripheral equipment when the orientation reproduction program 204 is executed.

In step S32 described above, the processor 50 may function as the input receiving unit 84 and receive an input of an allowable operation range RG of the robot 12 instead of the orientation reproduction position OP. For example, the processor 50 generates the input image IM for inputting the allowable operation range RG, and displays the image on the display device 60. The operator may operate the input device 58 while viewing the input image IM to provide an input for designating the allowable operation range RG (e.g., an input for designating a radius R from the origin of the robot coordinate system C1) to the processor 50.

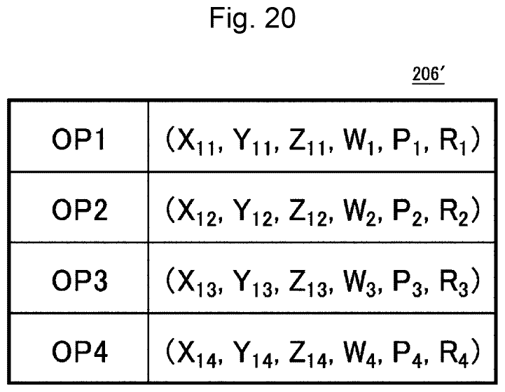

In this case, after determining YES in step S32, in step S33, the processor 50 generates a position data table 206′ based on the teaching orientation ORₙ extracted in step S31 and the allowable operation range RG received in step S32. FIG. 20 illustrates an example of the position data table 206′.

In the example illustrated in FIG. 20, the coordinates assigned the identifier “OPn” (n=11, 12, 13, 14) and stored in the position data table 206′ have the coordinates (Xⱼ, Yⱼ, Zⱼ) (j=1, 2, 3, 4) of the orientation reproduction position OP. The coordinates (Xⱼ, Yⱼ, Zⱼ) of the orientation reproduction position OP are different from at least one (e.g., all) teaching position TPₙ (Xₙ, Yₙ, Zₙ) defined in the welding work program 200 and are automatically generated by the processor 50 as coordinates within the allowable operation range RG received in step S32.

Then, in step S33, the processor 50 functions as the program generating unit 82 and generates the orientation reproduction program 204 based on the position data table 206′. That is, in this case, the processor 50 functions as the program generating unit 82 and generates the orientation reproduction program 204 based on the teaching orientation ORₙ extracted by the orientation extraction unit 78 in step S31 and the allowable operation range RG received by the input receiving unit 84 in step S32.

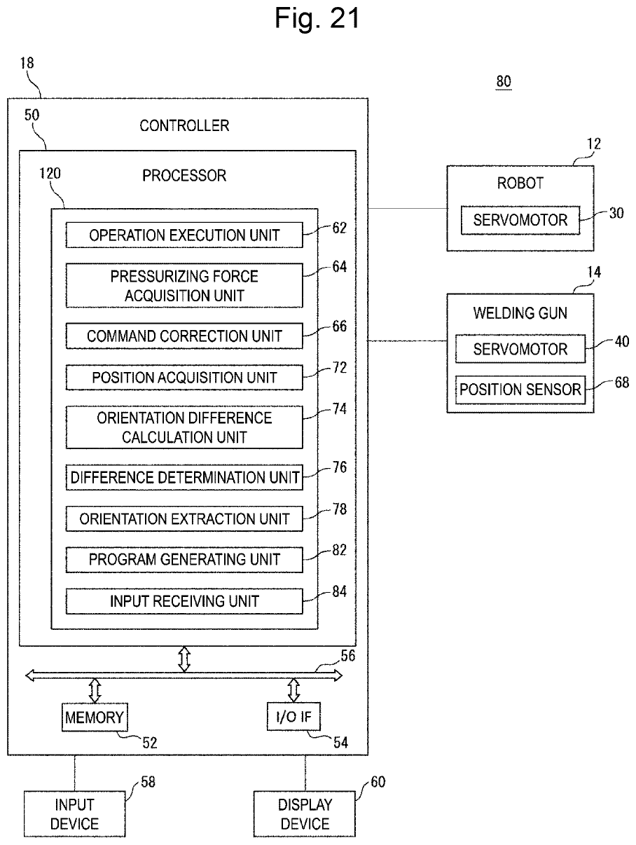

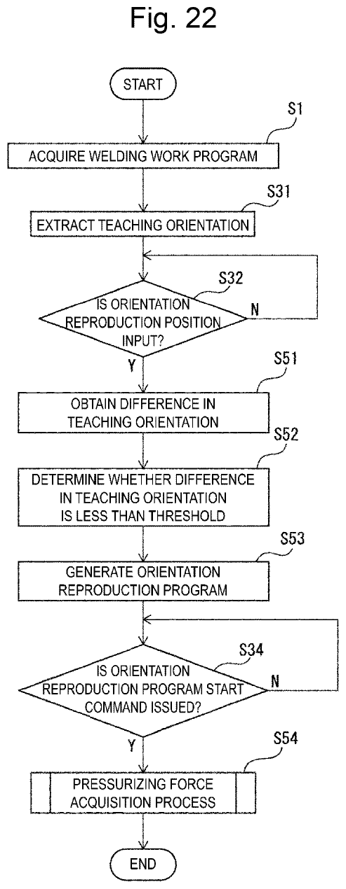

Next, still another function of the welding robot system 80 will be described with reference to FIGS. 21 to 23. The welding robot system 80 further executes a flow illustrated in FIG. 22. Note that in the flow illustrated in FIG. 22, the same processing as in the flow in FIG. 16 is denoted by the same step numbers, and redundant descriptions are omitted.

After the start of the flow in FIG. 22, the processor 50 executes step S1 to acquire the welding work program 200, and then executes step S31 and functions as the orientation extraction unit 78 to extract the teaching orientation ORₙ from the welding work program 200. Next, the processor 50 executes step S32 and determines whether or not the input of the orientation reproduction position OP (X₀, Y₀, Z₀) is received.

Upon determining YES in step S32 (that is, when the input of the orientation reproduction position OP (X₀, Y₀, Z₀) is received), in step S51, the processor 50 functions as the orientation difference calculation unit 74 and obtains the difference φ between the plurality of teaching orientations ORₙ extracted from the welding work program 200 in step S31.

Specifically, through the method described above in step S21, the processor 50 calculates each of a difference φ_{1_2} between the first teaching orientation OR₁ (W₁, P₁, R₁) and the second teaching orientation OR₂ (W₂, P₂, R₂), a difference φ_{1_3} between the first teaching orientation OR₁ (W₁, P₁, R₁) and the third teaching orientation OR₃ (W₃, P₃, R₃), and a difference φ_{1_4} between the first teaching orientation OR₁ (W₁, P₁, R₁) and the fourth teaching orientation OR₄ (W₄, P₄, R₄).

Further, the processor 50 obtains each of a difference φ_{2_3} between the second teaching orientation OR₂ (W₂, P₂, R₂) and the third teaching orientation OR₃ (W₃, P₃, R₃), a difference φ_{2_4} between the second teaching orientation OR₂ (W₂, P₂, R₂) and the fourth teaching orientation OR₄ (W₄, P₄, R₄), and a difference φ_{3_4} between the third teaching orientation OR₃ (W₃, P₃, R₃) and the fourth teaching orientation OR₄ (W₄, P₄, R₄).

In step S52, the processor 50 functions as the difference determination unit 76 and determines whether each difference φ obtained in step S51 is smaller than the predetermined threshold φₜₕ. Specifically, the processor 50 compares each of the difference φ_{1_2}, the difference φ_{1_3}, the difference φ_{1_4}, the difference φ_{2_3}, the difference φ_{2_4}, and the difference φ_{3_4} with the threshold φₜₕ, and determines whether φ_{1_2}<φₜₕ, φ_{1_3}<φₜₕ, φ_{1_4}<φₜₕ, _{2_3}<φₜₕ, φ_{2_4}<φₜₕ, or φ_{3_4}<φₜₕ holds.

When the difference φ among the first teaching orientation OR₁, the second teaching orientation OR₂, and the fourth teaching orientation OR₄ is smaller than the threshold φₜₕ as described in the above embodiment, the processor 50 determines that φ_{1_2}<φₜₕ, P_{1_4}<φₜₕ, and φ_{2_4}<φₜₕ hold.

In step S53, the processor 50 functions as the program generating unit 82 and generates the orientation reproduction program 204. Specifically, the processor 50 generates a position data table 206″ for the orientation reproduction program 204 based on the teaching orientation ORₙ with the difference φ being equal to or larger than the threshold φₜₕ among the plurality of teaching orientations ORₙ extracted in step S31 and the orientation reproduction position OP received in step S32.

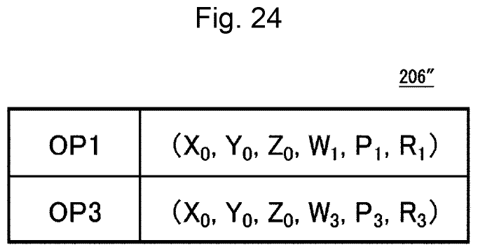

In the present embodiment, in step S52 described above, it is determined that the difference φ among the first teaching orientation OR₁, the second teaching orientation OR₂, and the fourth teaching orientation OR₄ is smaller than the threshold φₜₕ (that is, φ_{1_2}<φₜₕ, φ_{1_4}<φₜₕ, and φ_{2_4}<φₜₕ hold). Therefore, the processor 50 generates the position data table 206″ illustrated in FIG. 24 based on the first teaching orientation OR₁, the third teaching orientation OR₃, and the orientation reproduction position OP received in step S32.

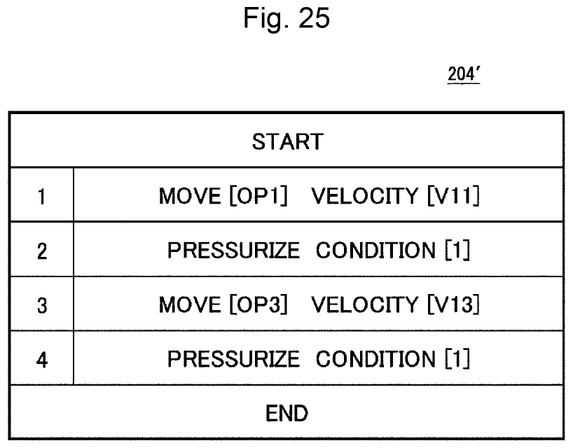

Then, based on the position data table 206″, the processor 50 generates an orientation reproduction program 204′ illustrated in FIG. 25. The orientation reproduction program 204′ includes a positioning instruction IN_{O} in the 2i−1th line (i=1, 2) and a pressurization instruction INR in the 2ith line. Thereafter, the processor 50 executes step S34, and proceeds to step S54 upon determining YES.

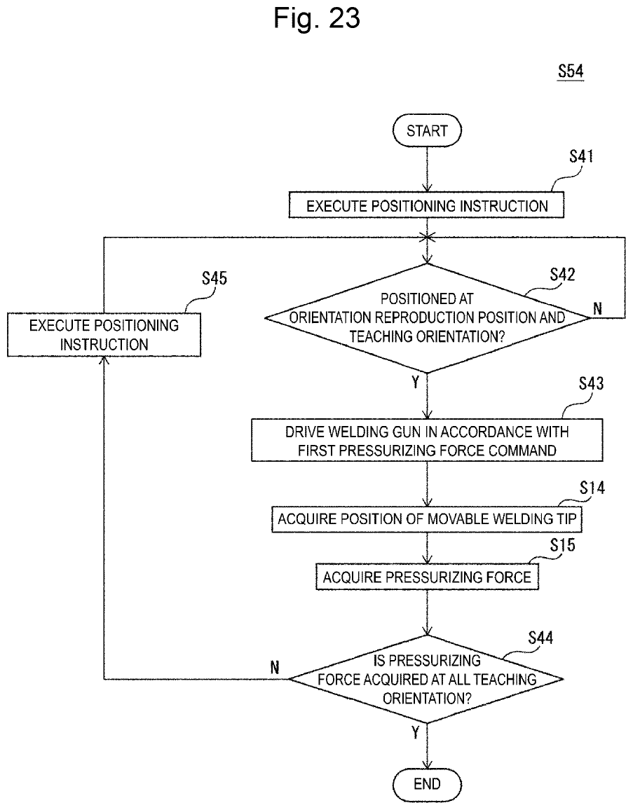

In step S54, the processor 50 executes a pressurizing force acquisition process. This pressurizing force acquisition process is illustrated in FIG. 23. Note that in the flow illustrated in FIG. 23, the same processing as in the flow in FIG. 12 or 17 is denoted by the same step numbers, and redundant descriptions are omitted.

The processor 50 acquires the pressurizing force F by executing the above-described steps S41 to S43, S14, S15, S44, and S45 according to the orientation reproduction program 204′ generated in step S53. As a result, the processor 50 acquires the pressurizing force F at the first teaching orientation OR₁ and the pressurizing force F at the third teaching orientation OR₃.

After finishing the flow in FIG. 23, the processor 50 executes the welding work program 200 for the actual welding work, and functions as the command correction unit 66 during the execution of the welding work program 200 to obtain the correction amount ΔF at each of the first teaching orientation OR₁ and the third teaching orientation OR₃ based on the pressurizing force F acquired in step S15 during step S54, and correct the original pressurizing force command F_{C_1} with the correction amount ΔF to obtain the pressurizing force command F_{C_1}′ at each the first teaching orientation OR₁ and the third teaching orientation OR₃.

On the other hand, for the second teaching orientation OR₂ and the fourth teaching orientation OR₄, the processor 50 corrects each original pressurizing force command F_{C_1} using the correction amount ΔF obtained for the first teaching orientation OR₁. In this way, the processor 50 obtains the pressurizing force command F_{C_1}′ at each of the second teaching orientation OR₂ and the fourth teaching orientation OR₄. That is, the processor 50 corrects the original pressurizing force command F_{C_1} using the common correction amount ΔF at the first teaching orientation OR₁, the second teaching orientation OR₂, and the fourth teaching orientation OR₄ which are approximate to each other.

As described above, in the present embodiment, the processor 50 functions as the operation execution unit 62, the pressurizing force acquisition unit 64, the command correction unit 66, the position acquisition unit 72, the orientation difference calculation unit 74, the difference determination unit 76, the orientation extraction unit 78, the program generating unit 82, and the input receiving unit 84 to correct the pressurizing force command F_{C} in accordance with the orientation OR of the welding gun 14.

Therefore, the operation execution unit 62, the pressurizing force acquisition unit 64, the command correction unit 66, the position acquisition unit 72, the orientation difference calculation unit 74, the difference determination unit 76, the orientation extraction unit 78, the program generating unit 82, and the input receiving unit 84 form a device 120 (FIG. 21) that corrects the pressurizing force command F_{C} in accordance with the orientation OR of the welding gun 14.

In the device 120, the orientation reproduction program 204′ is generated by using only the teaching orientations ORₙ with the difference φ between the orientations OR being equal to or larger than the threshold φₜₕ (that is, different orientations OR) among the plurality of teaching orientations ORₙ defined in the welding work program 200. According to this configuration, it is possible to optimize the number of orientations OR for positioning the welding gun 14 in the orientation reproduction program 204′.

In the present embodiment, in step S53, the processor 50 may generate the orientation reproduction program 204 illustrated in FIG. 19 instead of the orientation reproduction program 204′. In this case, steps S51 and S52 can be omitted from the flow in FIG. 22. Then, after determining NO in step S44 in FIG. 23, the processor 50 may execute steps S21 and S22 illustrated in FIG. 14.

In the embodiment in FIGS. 15 and 21, a case is described where the processor 50 functions as the program generating unit 82 and generates the orientation reproduction programs 204 and 204′. However, the present invention is not limited thereto, and in the embodiment in FIG. 15 or 21, the processor 50 may acquire the orientation reproduction program 204 or 204′ through downloading from another computer (a host controller, a production management server, or the like), for example.

In this case, the orientation extraction unit 78, the program generating unit 82, and the input receiving unit 84 can be omitted from the device 110 or 120. In this case, the processor 50 executes step S35 illustrated in FIG. 17 or step S54 illustrated in FIG. 23 according to the downloaded orientation reproduction program 204 or 204′.

In the above-described embodiment, a case is described where the processor 50 corrects the pressurizing force command F_{C_1} when executing the welding work program 200 for the actual welding work. However, the processor 50 may correct the pressurizing force command F_{C_1} during execution of the flow in FIG. 5, 12, 14, 16, or 22.

For example, in the flow in FIG. 5, 12, or 14, upon determining YES in step S7, the processor 50 may obtain the pressurizing force command F_{C_1}′ by correcting the pressurizing force command F_{C_1} at each teaching orientation ORₙ based on the pressurizing force F collected in step S6 or S15. Then, the processor 50 may create a data table DT storing the pressurizing force command F_{C_1}′ obtained for each teaching orientation ORₙ, in association with the teaching orientation ORₙ.

In this case, when the welding instruction IN_{W} in the welding work program 200 is read out in the actual welding work, the processor 50 acquires from the data table DT, the pressurizing force command F_{C_1}′ corresponding to the teaching orientation ORₙ (i.e., the teaching orientation ORₙ defined in the positioning instruction IN_{P} in the line preceding the welding instruction IN_{W}) at which the welding gun 14 is currently positioned.

Further, in the flow in FIG. 16 or 22, the processor 50 may obtain the pressurizing force command F_{C_1}′ by correcting the pressurizing force command F_{C_1} at each teaching orientation ORₙ based on the pressurizing force F collected in step S6 or S15 at the end of step S35 or S54 (that is, upon determining YES in step S44).

In the flow in FIG. 5, a case is described where the processor 50 causes the robot 12 to move the welding gun 14 at the velocity Vₙ defined in the positioning instruction IN_{P} (code “Vn”) in the welding work program 200 in step S2 or S8. However, in step S2 or S8 in FIG. 5, the processor 50 may move the welding gun 14 at a velocity Vₙ′ different from the velocity Vₙ defined in the welding work program 200 (e.g., lower than the velocity Vₙ). In this case, a flag FL′ for moving the welding gun 14 at the velocity Vₙ′ may be set to the controller 18. Alternatively, the flag FL′ may be provided to the code of the positioning instruction IN_{P} in the welding work program 200 acquired in step S1 described above.

In the above-described embodiment, a case is described where the processor 50 stops the servomotor 40 when the feedback FB1 from the load detection sensor LS reaches a value corresponding to the pressurizing force command F_{C_1} in steps S5 and S43. However, the present invention is not limited thereto, and in step S5 or S43, the processor 50 may stop the servomotor 40 when the movable welding tip 44 is forcibly stopped by coming into contact with the non-pressurizing object (fixed welding tip 36).

In this case, even when the welding instruction IN_{W} in the welding work program 200 is executed in the actual welding work, the processor 50 may stop the servomotor 40 when the movable welding tip 44 is forcibly stopped by coming into contact with the workpiece. The pressurization target object is not limited to the fixed welding tip 36, and can be any object (e.g., an iron plate) fixed to the fixed arm 34.

In this case, the processor 50 may execute the flow illustrated in FIG. 5, 12, 14, 16, or 22 according to a computer program PG2 that is stored in the memory 52 in advance. The functions of the device 70, 90, 100, 110, or 120 executed by the processor 50 (i.e., the operation execution unit 62, the pressurizing force acquisition unit 64, the command correction unit 66, the position acquisition unit 72, the orientation difference calculation unit 74, the difference determination unit 76, the orientation extraction unit 78, the program generating unit 82, and the input receiving unit 84) may be functional modules implemented by the computer program PG.

The welding work program 200 illustrated in FIG. 6, the orientation reproduction program 204 illustrated in FIG. 19, and the orientation reproduction program 204′ illustrated in FIG. 25 are merely examples, and may include any other types of instructions. For example, in the welding work program 200 illustrated in FIG. 6, the positioning instruction IN_{P} is defined in the 2i−1th line, and the welding instruction IN_{W} is defined in the 2ith line. However, in the welding work program 200, the positioning instruction IN_{P} and the welding instruction IN_{W} may be defined in the ith row (that is, the same row).

Similarly, in the orientation reproduction program 204 or 204′, the positioning instruction IN_{O} and the pressurization instruction INR may be defined in the ith row (the same row). The number of teaching positions TPₙ and the number of teaching orientations ORₙ defined in the welding work program 200 are not limited to four, and may be one or five or more. The same applies to the number of teaching orientations ORₙ defined in the orientation reproduction program 204 or 204′.

In the welding work program 200 illustrated in FIG. 6, a case is described where the identifier “TPₙ” (n=1, 2, 3, 4) is defined in the positioning instruction IN_{P}, and the position data table 202 illustrated in FIG. 7 is separately generated. However, the present invention is not limited thereto, and instead of the identifier “TPₙ”, the coordinates (Xₙ, Yₙ, Zₙ, Wₙ, Pₙ, Rₙ) may be directly described as a code in the positioning instruction IN_{P}. The same applies to the positioning instruction IN_{O} of the orientation reproduction program 204 or 204′.

In the welding work program 200 illustrated in FIG. 6, a case is described where the identifier [m] (m=1 in the example of FIG. 6) corresponding to the welding condition m is described in the welding instruction IN_{W}, and the data table of the welding condition m as illustrated in FIG. 8 is separately prepared. However, the present invention is not limited thereto, and instead of the identifier “m”, the value of the welding condition m (i.e., the pressurizing force Fₘ, the welding current Iₘ, and the welding time tₘ) may be directly described as a code in the welding instruction IN_{W}. The same applies to the pressurization instruction INR of the orientation reproduction program 204 or 204′.

The operator may make a change in part of the welding work program 200 acquired in step S1 described above, other than the positioning instruction IN_{P} (specifically, the teaching orientation ORₙ) to obtain a welding work program 200′. The processor 50 may execute the welding work by executing the changed welding work program 200′ at the time of the actual welding work.

For example, before executing the actual welding work, the operator may change the program name of the welding work program 200 (FIG. 6) acquired in step S1, may edit or add a code other than the positioning instruction IN_{P} in the welding work program 200, or may provide the above-described flag FL.

Further, the operator may replace the welding instruction IN_{W} in the welding work program 200 acquired in step S1 with an instruction for executing the pressurizing force acquisition operation FO, and the processor 50 may execute the flow in FIG. 5, 12 or 14 according to the replaced welding work program 200′. The welding work program 200 acquired in step S1 and the changed welding work program 200′ can both be regarded as welding work programs for causing the robot 12 and the welding gun 14 to perform the welding work.

Further, the welding work program 200 or 200′ may include a plurality of programs. For example, the welding work program 200 illustrated in FIG. 6 may include a first program 200A including instruction codes from the first line to the fourth line and a second program 200B including instruction codes from the fifth line to the eighth line. Similarly, the orientation reproduction program 204 or 204′ may include a plurality of programs.

In the above-described embodiment, a case is described where the welding condition 1 to which the identifier [1] is assigned is used in the welding work program 200 and the orientation reproduction programs 204 and 204′ (that is, the code “CONDITION [1]”). However, another welding condition m may be used.

In the above-described embodiment, a case is described where the processor 50 obtains the above-described correction amount ΔF and corrects the first pressurizing force command F_{C_1} with the correction amount ΔF to obtain the second pressurizing force command F_{C_1}′ when the actual welding work is performed. However, the present invention is not limited thereto, and the processor 50 may determine the second pressurizing force command F_{C_1}′ at each teaching orientation ORₙ before the actual welding work based on the pressurizing force F acquired in the above-described step S6 or S15.

In this case, the processor 50 may determine the second pressurizing force command F_{C_1}′ using the correction amount ΔF obtained as described above, or may determine the second pressurizing force command F_{C_1}′ by any calculation using the first pressurizing force command F_{C_1} and the pressurizing force F without using the correction amount ΔF. Then, the processor 50 may correct the first pressurizing force command F_{C_1} through replacement with the predetermined second pressurizing force command F_{C_1}′ during execution of the actual welding work (i.e., the welding work program 200 or 200′).

In the above-described embodiment, a case is described where the functions of the devices 70, 90, 100, 110, and 120 (the operation execution unit 62, the pressurizing force acquisition unit 64, the command correction unit 66, the position acquisition unit 72, the orientation difference calculation unit 74, the difference determination unit 76, the orientation extraction unit 78, the program generating unit 82, and the input receiving unit 84) are implemented in the controller 18.

However, the present invention is not limited thereto, and at least one of the functions of the device 70, 90, 100, 110, or 120 (e.g., the operation execution unit 62, the orientation extraction unit 78, the program generating unit 82, and the input receiving unit 84) may be implemented in a teaching device (a teaching pendant, a tablet terminal device, or the like) that teaches the robot 12 or another computer such as a PC an operation. In this case, a processor of the other computer functions as the device 70, 90, 100, 110, or 120.

The robot 12 is not limited to a vertical articulated robot, but, for example, may be any type of robot, such as a horizontal articulated robot or a parallel link robot. In addition, the concept of the present invention is not limited to C-type spot welding guns, and may be applied to any other welding guns such as X-type spot welding guns for example. Although the present disclosure has been described through embodiments above, the embodiments described above do not limit the scope of the invention claimed in the claims.

### REFERENCE SIGNS LIST

10, 10′, 80 Welding robot system
12 Robot
14 Welding gun
16, 16′ Pressurizing force sensor
18 Controller
62 Operation execution unit
64 Pressurizing force acquisition unit
66 Command correction unit
70, 90, 100, 110, 120 Device
72 Position acquisition unit
74 Orientation difference calculation unit
76 Difference determination unit
78 Orientation extraction unit
82 Program generating unit
84 Input receiving unit
200 Welding work program
204, 204′ Orientation reproduction program

1. A device configured to correct a pressurizing force command defining a pressurizing force of a welding gun, in response to an orientation of the welding gun, the welding gun being moved by a robot and configured to pressurize a workpiece to perform welding on the workpiece, the device comprising:
an operation execution unit configured to operate the robot so as to position the welding gun at a teaching orientation defined in a welding work program for causing the robot and the welding gun to perform a welding work;
a pressurizing force acquisition unit configured to acquire the pressurizing force when the welding gun is positioned at the teaching orientation by the operation execution unit and driven in accordance with a first pressurizing force command; and
a command correction unit configured to obtain a second pressurizing force command for when driving the welding gun at the teaching orientation during execution of the welding work program, by correcting the first pressurizing force command based on the pressurizing force acquired by the pressurizing force acquisition unit.

2. The device of claim 1, wherein the welding work program includes:
a positioning instruction for positioning the welding gun at a teaching position and the teaching orientation by operating the robot; and
a welding instruction for activating the welding gun to perform welding on a workpiece,
wherein the operation execution unit is configured to execute the positioning instruction included in the welding work program to position the welding gun at the teaching position and the teaching orientation by operating the robot, while not executing the welding instruction, and
wherein the pressurizing force acquisition unit is configured to acquire the pressurizing force when the operation execution unit positions the welding gun at the teaching position and the teaching orientation.

3. The device of claim 1, wherein the operation execution unit is configured to execute an orientation reproduction program including a positioning instruction for positioning, by operating the robot, the welding gun at the teaching orientation and a different position from a teaching position defined in the welding work program, while not including a welding instruction for activating the welding gun to perform the welding on a workpiece, and position the welding gun at the different position and the teaching orientation by the robot, and
wherein the pressurizing force acquisition unit is configured to acquire the pressurizing force when the operation execution unit positions the welding gun at the different position and the teaching orientation.

4. The device of claim 3, further comprising:
an orientation extraction unit configured to extract the teaching orientation from the welding work program; and
a program generating unit configured to generate the orientation reproduction program based on the teaching orientation extracted by the orientation extraction unit.

5. The device of claim 4, further comprising an input receiving unit configured to receive an input of the different position, wherein
the program generating unit is configured to generate the orientation reproduction program, further based on the different position received by the input receiving unit.

6. The device of claim 4, further comprising an input receiving unit configured to receive an input of an allowable operation range of the robot during execution of the orientation reproduction program, wherein
the program generating unit is configured to generate the orientation reproduction program, further based on the allowable operation range received by the input receiving unit.

7. The device of claim 1, wherein the pressurizing force acquisition unit is configured to acquire a first pressurizing force when the operation execution unit positions the welding gun at a first teaching orientation,
wherein the command correction unit is configured to obtain a correction amount for correcting the first pressurizing force command for driving the welding gun at the first teaching orientation to the second pressurizing force command, based on the first pressurizing force,
wherein the device further comprises:
an orientation difference calculation unit configured to obtain a difference between a second teaching orientation and the first teaching orientation; and
a difference determination unit configured to determine whether or not the difference obtained by the orientation difference calculation unit is less than a predetermined threshold,
wherein the operation execution unit is configured not to execute an operation of positioning the welding gun at the second teaching orientation, when the difference determination unit determines that the difference is less than the threshold, and
wherein the command correction unit is configured to obtain the second pressurizing force command for the second teaching orientation, by correcting the first pressurizing force command for driving the welding gun at the second teaching orientation, using the correction amount obtained at the first teaching orientation.

8. The device of claim 1, wherein the welding work program defines a first teaching position and a first teaching orientation, and a second teaching position and a second teaching orientation, at which the welding gun is to be positioned,
wherein the pressurizing force acquisition unit is configured to acquire a first pressurizing force when the operation execution unit positions the welding gun at the first teaching position and the first teaching orientation,
wherein the command correction unit is configured to:
obtain the second pressurizing force command for the first teaching position and the first teaching orientation, by correcting the first pressurizing force command based on the first pressurizing force; and
estimate the second pressurizing force command for the second teaching position and the second teaching orientation, based on the obtained second pressurizing force command and the first teaching position and the second teaching position defined in the welding work program, and
wherein the operation execution unit is configured not to execute an operation of positioning the welding gun at the second teaching orientation.

9. The device of claim 1, wherein the pressurizing force acquisition unit is configured to acquire the pressurizing force measured by a pressurizing force sensor when the welding gun positioned at the teaching orientation by the operation execution unit is driven in accordance with the first pressurizing force command.

10. The device of claim 1, wherein the welding gun includes a movable welding tip and a position sensor configured to detect a position of the movable welding tip,
wherein the device further comprises a position acquisition unit configured to acquire:
a first position detected by the position sensor when the welding gun positioned at a predetermined reference orientation is driven in accordance with the first pressurizing force command to pressurize a pressurization target object by the movable welding tip; and
a second position detected by the position sensor when the welding gun positioned at the teaching orientation by the operation execution unit is driven in accordance with the first pressurizing force command to pressurize the pressurization target object by the movable welding tip, and
wherein the pressurizing force acquisition unit obtains the pressurizing force at the teaching orientation by a predetermined calculation, based on the first position and the second position acquired by the position acquisition unit.

11. A controller of the robot comprising the device of claim 1.

12. A method of correcting a pressurizing force command defining a pressurizing force of a welding gun, in response to an orientation of the welding gun, the welding gun being moved by a robot and configured to pressurize a workpiece to perform welding on the workpiece, the method comprising:
operating, by a processor, the robot so as to position the welding gun at a teaching orientation defined in a welding work program for causing the robot and the welding gun to perform welding work;
acquiring, by the processor, the pressurizing force when the welding gun is positioned at the teaching orientation and driven in accordance with a first pressurizing force command; and
obtaining, by the processor, a second pressurizing force command for when driving the welding gun at the teaching orientation during execution of the welding work program, by correcting the first pressurizing force command based on the acquired pressurizing force.
